(19) United States
(12) Patent Application Publication
(10) Pub. No.: US 2004/0233930 A1
(43) Pub. Date: Nov. 25, 2004

(54) Apparatus and method for mobile personal computing and communications

(75) Inventor: John E. Colby JR., Maplewood, MN (US)

Correspondence Address: ALTERA LAW GROUP, LLC, 6500 CITY WEST PARKWAY, SUITE 100, MINNEAPOLIS, MN, 55344-7704, US

(73) Assignee: Modular Computing & Communications Corporation

(21) Appl. No.: 10/849,269

(22) Filed: May 19, 2004

Related U.S. Application Data
(60) Provisional application No. 60/471,587, filed on May 19, 2003.

(51) Int. Cl. H04J 15/00

(52) U.S. Cl. 370/464

(57) ABSTRACT

A hand-held mobile personal computing and communications device offers full operating system functionality and performance of modern laptops and desktop personal computers, along with seamless networking and session and application persistence for supporting voice, video and data communications. The device uses an ultra low voltage processor and ample low power mass storage for effectively running complete versions of modern operating systems and associated applications with extended battery life. The device also utilizes modular peripherals to extend battery life and increase the effectiveness of the overall system. The device includes multiple broadband wireless communications technologies along with integrated cellular communication technologies for supporting real-time voice, video and data transmission. Various processes are provided for managing connectivity and communications.

### CROSS-REFERENCE TO RELATED APPLICATION

This application claims the benefit of U.S. Provisional Patent Application Ser. No. 60/471,587, filed May 19, 2003 (Colby, “Personal computing and communications device and systems using such device”), which hereby is incorporated herein by reference thereto in its entirety.

### BACKGROUND OF THE INVENTION

1. Field of the Invention

The present invention relates to apparatus and methods for mobile personal computing and communications, and more particularly to devices for mobile personal computing and communications, methods of controlling the devices, and methods of use thereof.

2. Description of the Related Art

Non desk-bound users include those individuals considered “mobile” in their role within their job function at their companies, individuals such as field sales personnel and customer service representatives. These individuals, often employees, work throughout their building(s) or campus to perform their role and usually travel outside the reach of their traditional network connectivity. As more mobile solutions come to market, the base of non desk-bound users will expand to include all users that can benefit from having real-time access to their data independent of location.

Originally, computer devices began as simple terminals wired to large mainframe computers: the computer applications were executed on the mainframes. Users sent commands and data through the terminals to the mainframes where the applications performed their routines and sent resulting information back to the end-user's terminals. Such terminals were not useful to mobile workers.

With the advent of personal computers (“PCs”) and Client/Server technology, corporations found it productive to allow end users to have some applications run on the PC's and other applications run on the servers in the data centers, and made accessible through wired networks. These PCs, referred to as “fat-clients,” now contain enough processing power, memory and data storage capability to operate as stand-alone systems.

As corporate administrative processes were increasingly computerized, corporations desired mobile devices for their mobile workers. Laptop computers gave mobile users similar (although usually less) power of a desktop PC in a form factor that was easier to carry and connect to the corporate network wherever a phone line could be found.

In 1996 Palm Pilots were introduced, providing personalized scheduling (calendars) and contact directories. The Palm Pilot and other hand held wireless devices, also known as personal digital assistants (“PDAs”) were easy to carry but normally did not connect to corporate networks. Upon arriving back to their desktop computer, the user would “synchronize” the date in the PDA by placing the device into a specialized communications “cradle”. The use of this device gave the mobile user another productivity tool, however most corporations (and some individuals) have resisted deploying PDAs because the supported applications are limited, the screen size and input mechanisms are too small, and a clumsy synchronization process is required to make them truly useful. Because of these limitations, most corporations will not pay for or even support their employee's PDAs and Smart-Phones. There is also a belief, and hope, that “something better” will come along to address this dilemma.

In today's business environment, workers perform their job function using multiple information tools, such as pen and paper as well as various computer devices such as cell phones, pagers, laptop computers and personal digital assistants (“PDAs”). This plethora of devices creates a heavy burden for the mobile worker and associated support personnel by introducing multiple devices with varying synchronization points for their data. Moreover, enterprises generally, and in particular large enterprises such as companies composed of many mobile employees, spend significant amounts of their available resources to acquire, configure and support this proliferation of distinct devices. Enterprises and users both would prefer a more cost-effective solution to address their productivity needs with respect to mobile devices, especially outside of the enterprise, while minimizing their reliance on unproven and speculative technologies.

Hence, a strong demand exists for mobile personal computing and communications devices that enhance productivity, as well as related wireless network design and implementation services, voice and data carrier services, and value-added and premium services.

### BRIEF SUMMARY OF THE INVENTION

One embodiment of the present invention is a modular computing environment comprising: a self-powered mobile personal computing and communications device comprising: a microprocessor capable of running standard business application software; a mass storage device coupled to the microprocessor; a GSM wireless cell phone circuit coupled to the microprocessor, the GMS wireless circuit having a SIM card that is accessible to the microprocessor for authenticating user identity and for supporting secure network connections through the GSM wireless circuit and the broadband wireless circuit; a local area wireless networking circuit coupled to the microprocessor; a personal area wireless networking circuit coupled to the microprocessor; a wired connectivity port coupled to the microprocessor; and a main screen coupled to a microprocessor; and a self-powered mobile user interface device comprising: a standard business size display screen; a standard business size keyboard; and an I/O circuit coupled to the display screen and to the keyboard; the mobile personal computing and communications device being coupled to the mobile user interface device through at least one of the local area wireless networking circuit, the personal area wireless networking circuit, and the wired connectivity port.

A further embodiment of the invention is a method for operating a mobile personal computing and communications device, comprising: securely managing communications across multiple networks by requesting connection to a web site from the mobile personal device; establishing a first secure connection between the mobile personal device and a connection manager; maintaining the first secure connection seamlessly across multiple networks with session persistence; establishing a second secure connection between the connection manager and the web site; and managing the connection between the mobile personal device and the web site with the connection manager, through the first secure connection and the second secure connection; reconfiguring the mobile personal computing and communications device from a prior user to a new user by identifying the new user; authenticating the new user to take ownership of the device; disposing of data and applications of the prior user from the device; and establishing data and applications for the new user on the device seamlessly across multiple networks with session persistence; managing communications by establishing connection parameters for a plurality of connection types; establishing weightings for the connection parameters; detecting connections available to the mobile personal device; evaluating the connection parameters for the detected connections; and applying the weightings to the evaluated connection parameters to select one of the detected connections for the communications; and selectively triggering processes and applications on a mobile personal device by monitoring events accessible to the mobile personal device from local and remote processes and applications; identifying triggers in the monitored events; initiating autonomous execution of other processes and applications on the mobile personal device from the triggers; and monitoring the initiated processes and applications.

### BRIEF DESCRIPTION OF THE SEVERAL VIEWS OF THE DRAWINGS

FIG. 1 is a block diagram of an embodiment of a mobile personal device, in accordance with the present invention.

FIG. 2 is a perspective view showing various aspects of an embodiment of a mobile personal device, in accordance with the present invention.

FIG. 3 is a perspective view showing various aspects of an embodiment of a mobile personal device set into a docking cradle, in accordance with the present invention.

FIG. 4 is a perspective view of an alternative embodiment of a mobile personal device, in accordance with the present invention.

FIG. 5 is a perspective view of an alternative embodiment of a mobile personal device, in accordance with the present invention.

FIG. 6 is a perspective view of a user interface peripheral that combines a thin and light weight keyboard and a thin and light weight screen, for use with a mobile personal device.

FIG. 7 is a front plan view of a mobile personal device having an auxiliary I/O component that is a low power screen and mousepad combination located on the same general surface as a main display screen.

FIG. 8 is a perspective view of a mobile personal device having an auxiliary I/O component that is a low power screen and mousepad combination located on a surface of the device other than the surface on which the main display screen is located.

FIG. 9 is a schematic block diagram of an illustrative architecture for a mobile personal device.

FIG. 10 is a schematic diagram of a non-private network architecture having a connection manager.

FIG. 11 is a schematic block diagram of an illustrative architecture for a mobile virtual network operator.

FIG. 12 is a block schematic diagram showing an overview of an illustrative communications management architecture.

FIG. 13 is a block schematic diagram showing various functions of a connection manager that is part of the communications management architecture of FIG. 12.

FIG. 14 is a block schematic diagram showing various detailed functions for prioritizing and resolving connections options.

FIG. 15 is a block schematic diagram showing various detailed functions carried out by a connection monitor.

FIG. 16 is a block schematic diagram showing various detailed functions carried out by a security manager.

FIG. 17 is a flowchart of an illustrative process for handling a variety of different communications types.

FIG. 18 is a schematic block diagram showing various functions of a communications controller.

FIG. 19 is a flowchart of an illustrative process for reconfiguring a mobile personal device.

### DETAILED DESCRIPTION OF THE INVENTION, INCLUDING THE BEST MODE

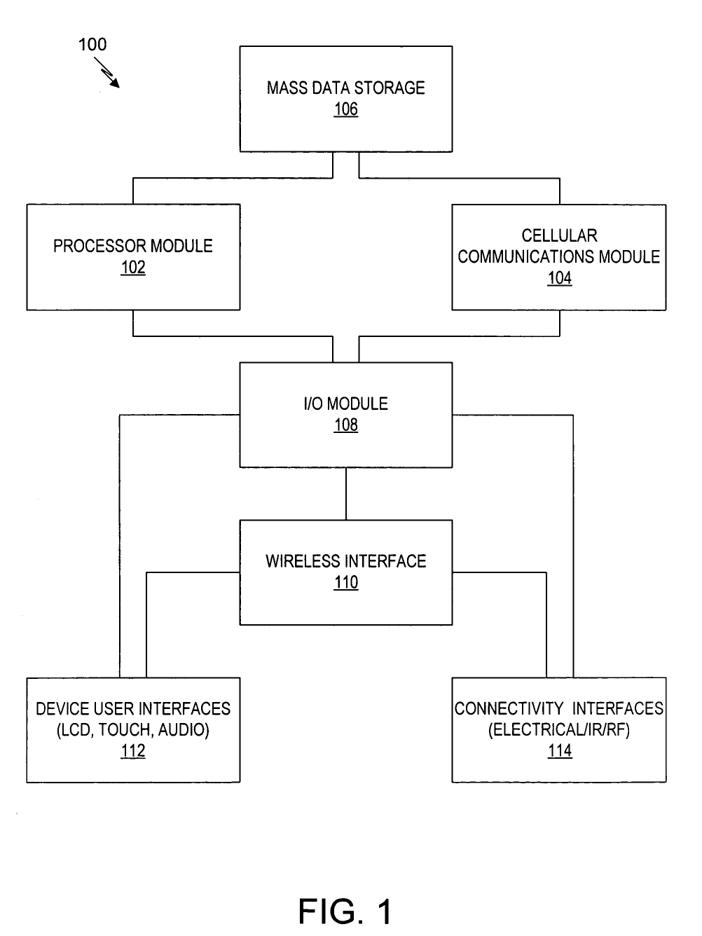

A mobile personal device is provided with suitable computing performance, storage capacity and wireless network connectivity to support multi-function processing and multi-mode communications, to work seamlessly with multiple wireless and wired networks and implementation services, to accommodate a variety of voice and data carrier services, to access value-added and premium services, and to maintain session and application persistence. A block diagram of an embodiment of a mobile personal device is shown in FIG. 1.

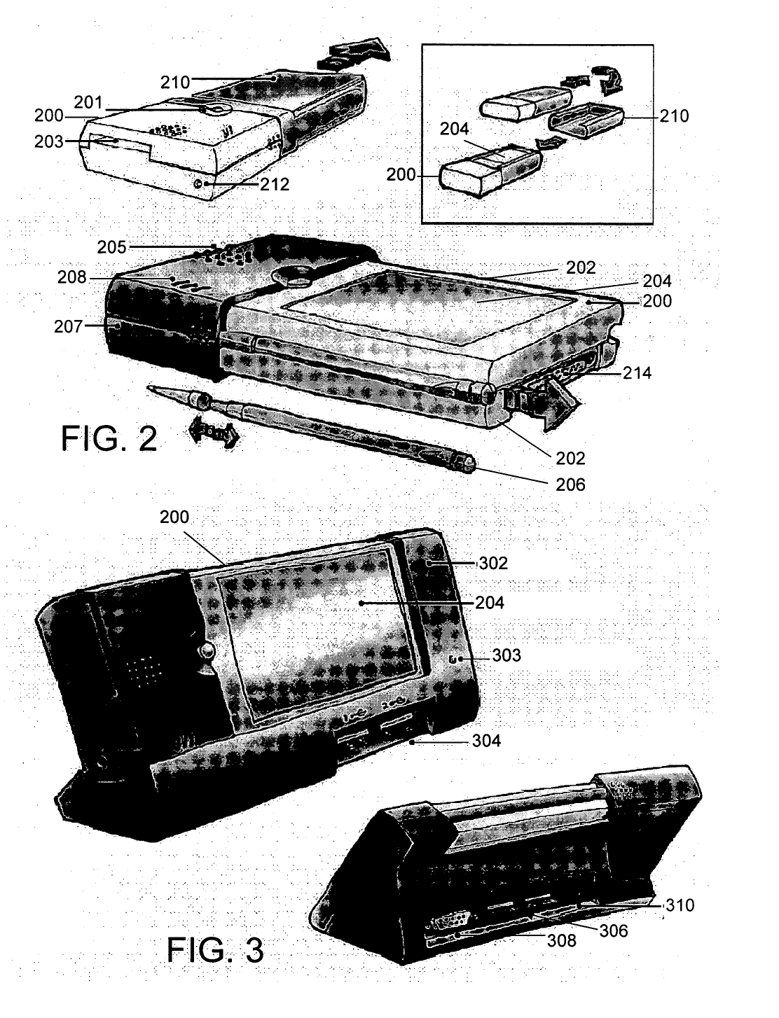

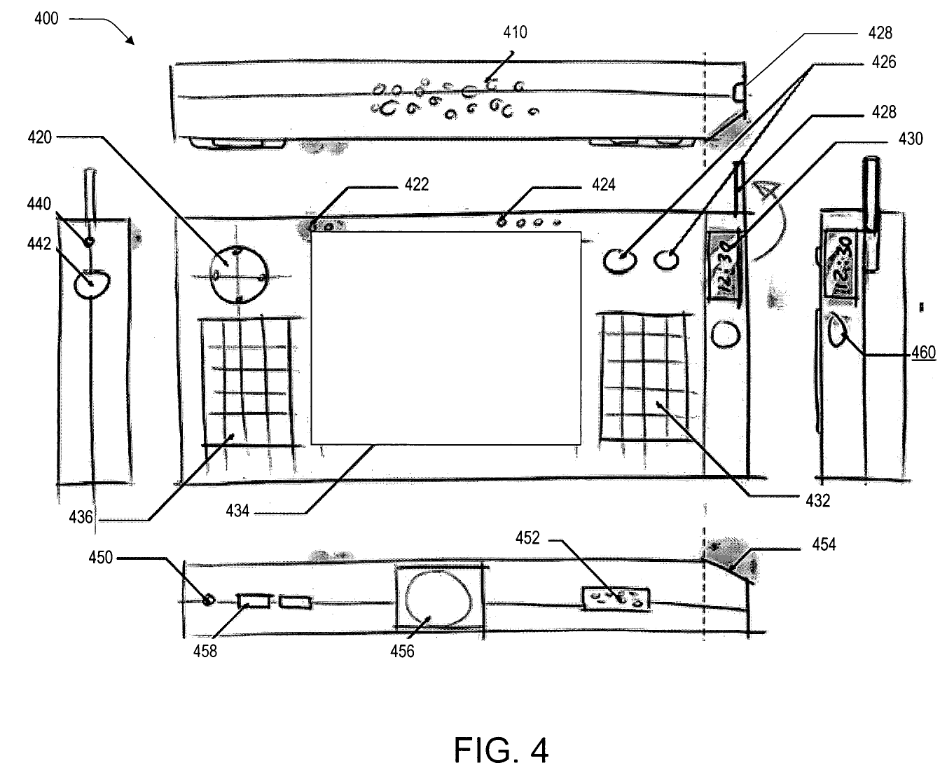

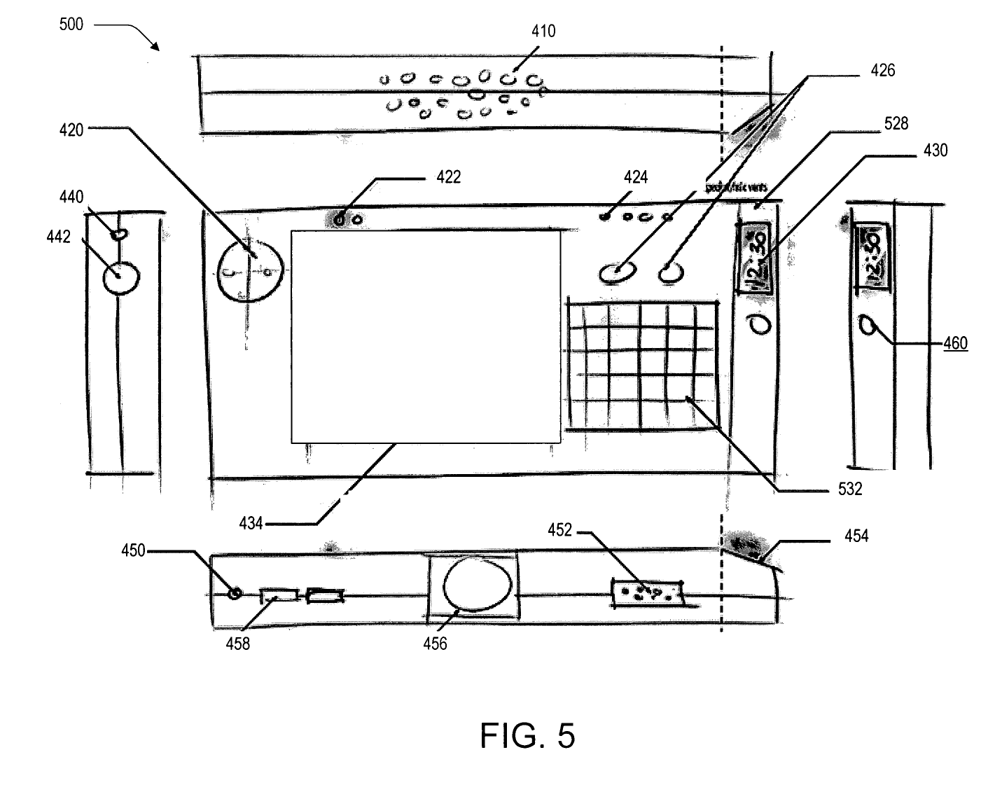

The mobile personal device may have a suitable size and form factor to allow it to be carried in a pocket, briefcase, or purse, or worn on a belt like a pager. Suitable embodiments of a mobile personal device are shown in the perspective views of FIG. 2, FIG. 4 and FIG. 5.

The mobile personal device contains a high-performance central processing unit (“CPU”) capable of supporting an advanced operating system such as the Windows XP Professional operating system available from Microsoft Corporation of Redmond, Wash. Other suitable operating systems include Linux and Unix.

The mobile personal device includes a display screen that may be integrated with a touch-pad.

The mobile personal device may include wireless transceivers for wireless personal area networks (“WPAN”), wireless local area networks (“WLAN”), wireless wide area networks (“WWAN”), and cellular voice and data networks. It also contains integrated cellular telephony capability, such as CDMA, TDMA, GSM, and others, including other frequencies and spectra, to support voice and data services via cellular telephony or any others such as UHF, VHF, satellite, and so forth. For instance, the user may be conducting a voice telephone call while the mobile personal device completes a transaction via the data signal on the same voice connection, or on one of the other connections set forth above, or on a proprietary connection. Software may be used to manage the network connectivity and provide a variety of controls. Options for connectivity include quality of signal and cost of connection, among others, and a prioritization of the connections may be based upon a user profile.

In addition to voice support, the mobile personal device provides access to the user's latest enterprise data located on centralized servers, which can be accessed via both wired and wireless data services. While the mobile personal device can be fully utilized on a stand-alone basis, it is anticipated that most users will utilize these wireless capabilities to remain current with the most up-to-date information.

The mobile personal device includes a mass data storage unit capable of permanent data storage, or storage of information even when electrical power is removed. Suitable storage media include disk drives and solid-state devices. The mass data storage unit is preferably relatively small; for example, a disk drive may be around the size of a matchbook and weigh less than an ounce, and a solid state device may be of similar dimensions. Such a small disk drive typically contains the same working parts of an ordinary drive: spindle motor, bearings, and read and write heads. Its spinning platter contains, for example, 40 Gigabytes of storage capacity. The use of a small mass data storage unit along with new, low-voltage microprocessors that have become available, results in a compact device about the size of a larger Smartphone or PDA.

The mobile personal device also may include a suitable frame buffer and device drivers for a peripheral wired or wireless display, for example an LCD screen (display panel). Such a screen is larger and easier to use than the integrated display available on the mobile personal device. It is anticipated that most users prefer a screen capable of a full-page display. The mobile personal device is also capable of using common input/output devices such as a keyboard and mouse, the connectivity to which may be either wired or wireless.

The mobile personal device also may include the capability of being used with a networked docking station via wired or wireless connectivity. This complementary accessory provides connectivity between the mobile personal device and a keyboard, mouse, display, CDRW and DVD drives, and an immense amount of other local peripherals as are available and as may become available, as well as full network access. Hard wire connectivity may also provide for electrical power for recharging a rechargeable battery, such as a lithium ion battery in the mobile personal device. With the connectivity provided by the docking station, users are provided the full function of a traditional desktop operating environment. Since the latest data for the individual user may be stored on his or her mobile personal device, users can share the use of docking stations as well as display screens and other peripherals, hence reducing support costs and simplifying management. An suitable embodiment of a mobile personal device set into a docking station is shown in the perspective views of FIG. 3.

The mobile personal device also may include integrated Global Positioning System (“GPS”) technology. GPS enables the device to be accurately located to provide support such as, but not limited to, location-based services or functions, including scheduling and transaction related services in conjunction with applications running on the microprocessor and emergency services in conjunction with the cellular subsystem.

The mobile personal device also may include various enhancements to the telephony capability. An earpiece, which may be wired or wireless and running a wireless protocol such as Bluetooth, may be used to provide hands free cellular telephony capabilities and can be used while running computer applications and/or traveling in a car. The mobile personal device may also include an integrated speakerphone capability to enable “hands-free” or group participation in conference calls over a single line. The user may place his mobile personal device on the table and enable the integrated speaker. The user and others may group around the user's mobile personal device just as they would any other telephony device.

The mobile personal device also may provide for collaboration via the network connectivity on the computer.

Various power options may be used in the mobile personal device. When provided with a single battery, power management techniques such as microprocessor speed control, display screen and disk drive deactivation, and sleep mode may be practiced. Components within the mobile personal device may be powered differently, such as by the use of power control systems that allocate and even disable power selectively to the different components based on their respective priorities, or by the use of individual batteries for each component, increasing battery life for the entire system.

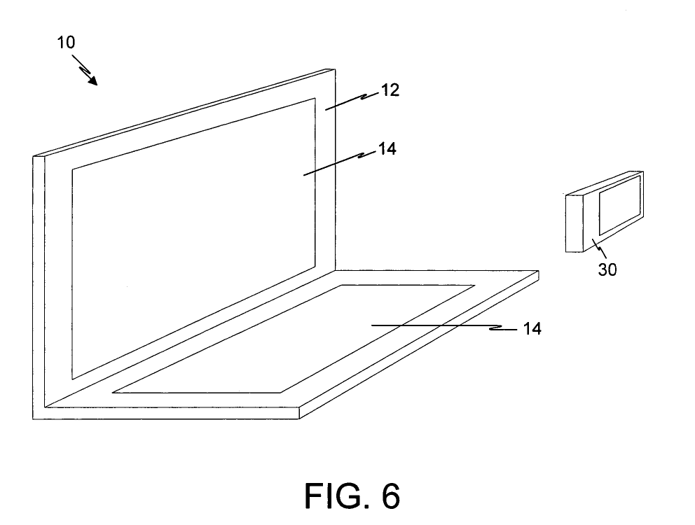

The separation of some other components as peripherals, or modules, also reduces the weight of each individual component, most importantly the hand held component. An example is a display screen peripheral having an extremely light weight but capable of displaying a full page color screen, and designed to provide the user with a feeling similar to carrying a clipboard. Another example is the user interface peripheral 10 shown in the perspective view of FIG. 6, which combines a full size thin and light weight keyboard 16 with a mousepad or other navigation device and a full screen size (e.g., 15 inch) thin and light weight display screen 14 for use with mobile personal device 30. The keyboard, screen and navigation device are incorporated into a suitable carrying case, which may be a hardcase made of such materials as plastic or metals, or a softcase such as, illustratively, a soft sided yet supportive portfolio 12 having crushable edges and a bendable spine capable of supporting the display screen at a variety of angles relative to the keyboard. The portfolio 12 may be securely closed by the use of a clips, snaps, a zipper, and so forth. The portfolio also includes appropriate control and connectivity circuits (not shown), for which suitable examples are well known in the art. Either wired connectivity using any suitable video port such as DPI or VGA, or wireless connectivity using such technologies as 802.11 and future fast bandwidth PAN technologies may be used. A separate power source may be used for the display screen peripheral.

With a mobile personal device resting in a pocket or clipped to a belt, an easily carried user interface which may be, for example, a screen or screen and keyboard combination, and a small earpiece, the user becomes fully equipped with a “hands free” cellular telephone, full PC capabilities, a connection to the Internet, and connectivity to enterprise networks. The PC capabilities may be accessed either by operating the mobile personal device directly, which is especially useful when the user is in motion, or by operating the user interface peripheral when the user is at rest.

Technical Aspects of an Illustrative Embodiment of the Mobile Personal Device

Recent surveys on mobile devices indicate that the most important hardware features, in order, for a new device are 1) long battery life, 2) lightweight, 3) instant-on capability, 4) pen input for data entry, navigation through menus, and handwriting recognition, and 5) large color display. Surveys also indicate that the most important software features are 1) the ability to track calendar and schedule, 2) manage contact information, i.e. names, addresses, phone numbers, 3) synchronize files and e-mail from desktop or laptop computers, 4) e-mail access, and 5) provide authentication and security information. The mobile personal device described herein provides all of these features as well as what the user does not believe they can have—full size PC functionality. Additionally, the mobile personal device described herein provides seamless network switching and session persistence, as well as sophisticated message prioritization and handling.

Uniquely combining the environment of the cell phone, the true personal computer, and integrated wireless networking, the mobile personal device replaces or supercedes the devices a target set of users have and carry today. The phone functionality of this device may be equal to the highest end of the cell phone market. It is a fully capable cell phone first with a display quality equal to none. It may also have data transfer capability that is leading edge as the world comes to realize the importance of this capability in hand held devices.

The computer may also be a high quality portable device. When the mobile personal device is docked, its capabilities are extended via standard peripheral devices to a full desktop experience. A near full desktop experience may be realized by use of the user interface peripheral of FIG. 6 with the mobile personal device. The mobile personal device is especially suitable for extremely mobile users who spend most of their time working away from the office.

Preferably, the mobile personal device is optimized for portability and long battery life without losing the features of a full size notebook. With this full range of function the device with its possible options and services can help its users to meet the needs of their businesses and personal life. In one particular illustrative embodiment, the technical specifications of the mobile personal device are as shown in TABLE 1.

TABLE 1

| | |
|---|---|
| Processor | Intel Dothan ULV 1.1 GHz or similar |
| Chipset | Montara/ICH or equivalent |
| Operating System | Microsoft Windows XP Professional and/or |
| | Linux or equivalent |
| Applications | Microsoft Office and other off-the-shelve |
| | applications including customer specific/vertical |
| | market requirements or equivalent |
| Random Access | 512 MB |
| Memory | |
| Universal Serial Bus | USB 1.1 and/or 2.0, 2 ports |
| Disk Capacity | 40 GB Enhanced IDE, Ruggedized or equivalent |
| Wireless LAN | 802.11 (802.11a/b/g option) |
| Wireless PAN | Bluetooth Class 2 |
| Audio | AC97 |
| Graphics | Embedded UMA Graphics Display 4″ or |
| | 5″ VGA or equivalent |
| Media Devices | Via USB Wireless Cell GSM/GPRS, MC45 or |
| | equivalent |
| Battery | One or more Smart LiON Power Via AC or option |
| | DC charger or equivalent |
| Docking Station | 4 USB/DVI/Ethernet/charger connection or |
| | equivalent |

Major illustrative modules and connectors of the mobile personal device are as listed in TABLE 2.

TABLE 2

```
  1) Dothan - Processor Bus
  2) Bluetooth Module
  3) LAN/HPNA
  4) LPC Interface
  5) AC97 Connector
  6) CODECs
  7) Super I/O
  8) Hub Interface 1.5
  9) Montara Nbridge chipset
10) DDR 200/266 MHz
11) ATA 100
12) LPC Interface
13) ICH-4M
14) LCD Panel - VGA (4″ or 5″)
15) PCI 2.2
16) Card Bus
17) Dock Connector
18) Mini-PCI 802.11 Module
19) USB 2.0/1.1 - 6 ports
20) DVOB, DVOC, VGA
```

The mobile personal device is suitable for extremely mobile users who spend most of their time working away from the office. This device is optimized for portability and long battery life without losing the features of a full computer along with the cell phone and data transfer capability.

FIG. 1 is a schematic block diagram of one example of a suitable architecture of a mobile personal device 100. The device 100 is arranged as internal modules, although this arrangement is illustrative and other device architectures may be used. In particular, advanced fabrication technologies permit the various discrete functions to be implemented on one or more highly integrated substrates. The processor module 102, which carries out the major processing functions, includes a microprocessor chip set and associated memory, and is capable of running a standard type of operating system that normally runs on a desktop or laptop computer, such as Windows XP or equivalent. Accordingly, the processor module 102 may run many different types of software applications, just like laptop and desktop computers. This computing capability is different from that of a cell phone that has a PDA capability, or a miniaturized computer that runs a reduced operating system such as Windows CE. Such computers are not capable of operating the same software applications as are normally run on laptop or desktop computers, such as full versions of the Microsoft Office suite of business software tools that includes word processing, spreadsheet, and presentation applications.

One way of measuring performance of the microprocessor module is for it to be able to be used in the BAPCO MobileMark benchmark measurement tool. For example, the BAPCO MobileMark 2002 benchmark measurement tool analyzes the operation and efficiency of the microprocessor unit when using common software applications, including Adobe Photoshop v. 6.01, Macromedia Flash 5, McAfee VirusScan 5.13, Microsoft Excel 2002, Microsoft Outlook 2002, Microsoft PowerPoint 2002, Microsoft Word 2002, Netscape Communicator 6.0 and WinZip 8.0.

A cellular communications module 104 provides cellular communications capabilities, and allows the device 100 to operate as a cell-phone.

A mass data storage unit 106 provides data storage for at least the processor module 102. The mass data storage unit 106 may be any suitable type of mass data storage unit, for example a magnetic storage unit, and preferably provides read/write data storage capabilities. One example of a mass data storage unit is a magnetic hard disk, although other types of data storage may also be used. The mass data storage unit preferably provides permanent data storage, that is storage of data even when power is removed. Permanent data storage does not require that the data be unerasable.

The mass data storage unit 106 contains enough capacity to enable the mobile personal to run business software applications normally run on a laptop or desktop computer, and preferably has a capacity of 2 Gbytes or greater. This compares with currently available hand-held devices where the storage capacity is approximately 32 MB. This additional storage capacity enables users to replicate the same functionality as current laptop or desktop computers without the associated weight or bulk of those larger devices. This additional capacity enables new applications, for example “lifetime phone conversation recording”, in which all telephone conversations taking place on the device 100 may be recorded over its lifespan. Furthermore, because the mass data storage unit saves data permanently, the information is not lost if battery power to the mobile personal device is lost.

The processor module 102 and cellular communications module 104 communicate via an I/O module 108 to various I/O devices having either wired or wireless connectivity. For example, a wireless interface module 110 is provided to allow for wireless communication.

Various device user interfaces 112 may be provided on the device 100 itself; for example, an LCD display to display information to the user, a touch screen overlying the LCD display as an input device to receive information form the user, and audio input and output channels. The audio input channel may include a microphone to receive audio input from the user, and the output channel may include a speaker to furnish sound to the user. The audio channels are useful for phone conversations over the cellular communications module 104, including cell phone speakerphone communications. The audio channels may also be used to furnish commands for voice activated processes and data for processes run by the processor module 102 (for example, voice recognition for generating alphanumeric commands and data from oral communications), and to communicate information in audio form (for example, using a text to audio translator) from the running operating system and applications.

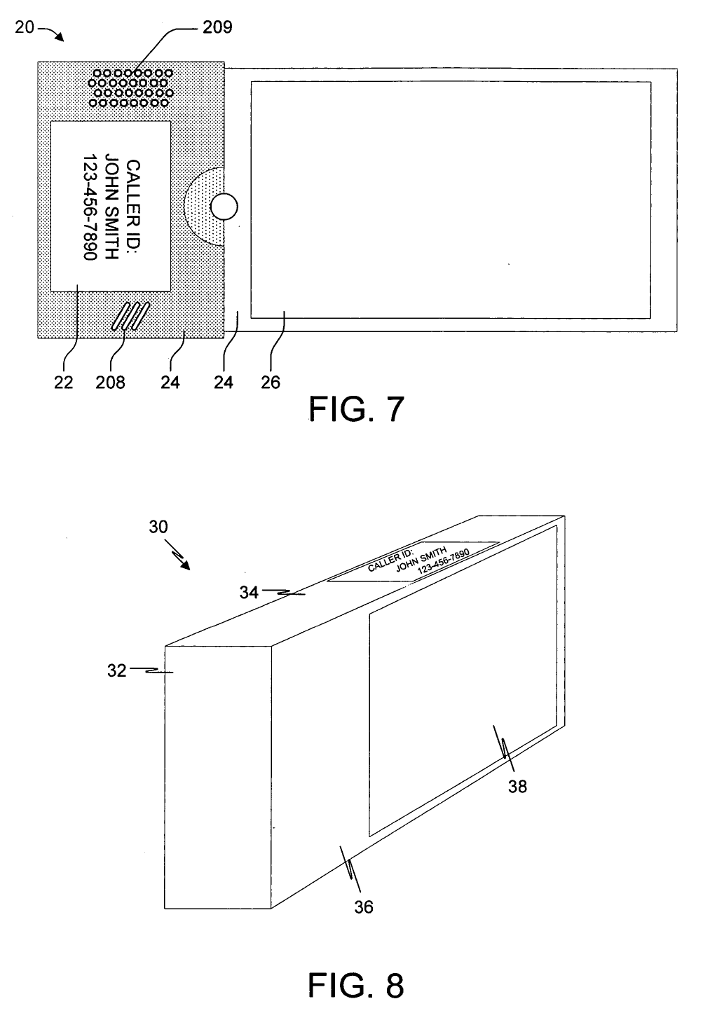

FIG. 7 is a front plan view of a mobile personal device 20 having a user I/O component 22 that is a low power auxiliary display screen and mousepad combination located on the same general surface 24 as a main display screen 26. FIG. 8 is a perspective view of a mobile personal device 30 having a user I/O component 34 that is a low power auxiliary display screen and mousepad combination located on a surface 32 of the device 30 other than the surface 36 on which a main display screen 38 is located, which may be a long side as shown, but which may also be a short side or the back opposite the main display screen 38. The screen part of the I/O components 22 and 34 is available to the cellular communications module 104 when the main screens 26 and 38 are powered off, to display various information pertaining to phone calls such as, for example, the caller ID of an incoming call, the number or ID of a dialed call, and so forth. The screen part of the I/O components 22 and 34 is smaller than and may have less resolution and fewer colors (and may even be monochromatic) relative to the main screens 26 and 38, and may be designed to dissipate minimal power. The I/O components 22 and 34 are made touch-sensitive in a manner well known in the art, and may serve as mousepads when the processor module 102 is in operation to control the position and action of an on-screen cursor displayed in association with the operating system or active application. Mouse buttons may be simulated by a “tapping” action, which is per se well known in the art, on the components 22 and 34, or implemented by separate buttons (not shown), which are per se well known in the art, located near an edge of the components 22 and 34.

A mobile personal device that is intended for applications in which security is important preferably is provided with a user identity component. While many different types of user identity components are suitable, an illustrative user identity component is the BioTouch® fingerprint reader available from Identix Incorporated of Minnetonka, Minn. The BioTouch fingerprint reader is an optical scanning device that uses CMOS camera technology.

A mobile personal device intended for applications in which imaging is important preferably is provided with a video camera. The video camera (not shown) may be low or high resolution, depending on the imaging applications for which the mobile personal device is intended, such cameras being well known in the art. Where imaging and security are important, the camera optics may have a variable depth of field, whereby the camera in near field mode acts as a scanner for fingerprint capture and two dimensional image capture, and in far field acts as a conventional camera for capturing three dimensional objects. The two dimensional image capture capability includes the ability to capture text, signatures and handwriting, graphics and pictures. When combined with an optical character recognition (“OCR”) capability or handwriting recognition capability either running on the mobile personal device or accessible to the mobile personal device from a remote server over a connected network, the near field camera or scanner enables the mobile personal device to extract the information content of the scanned image and use it in any desired application. To permit the mobile personal device to be used in facilities that prohibit cameras, the mobile personal device may be provided with a camera lockout that turns off the camera or disables the far field functionality. This may be done by a facility guard using password or fingerprint security specific to the camera lockout.

The mobile personal device 100 may also have one or more interfaces 114 for connection to peripheral devices, such as a docking station, external keyboard, external monitor, and the like. The interfaces 114 may include, for example, various sockets for plugging peripherals into the device 100. An example of a suitable interface is the universal serial bus, or USB interface. Other examples include a microphone jack, a headphone jack for private audio output, and a multiconnector jack for a hands free headset. The interfaces 114 may also include wireless connectivity to establish a personal area network, including connectivity options such as Bluetooth, infrared, and so forth. The interfaces 114 may also include wireless connectivity to local area networks, including Wi-Fi connectivity. Suitable Wi-Fi technology includes 802.11 (a)(b)(g), which provides Ethernet network connectivity incorporating secure wireless authentication protocol (LEAP). The interfaces 114 may include proprietary connectivity options as well, such as connectivity to proprietary sensors to sense signals from proprietary devices such as implanted as well as noninvasive medical devices, security tags, and so forth.

The peripherals and other accessories enable a modular approach to personal computing. In this approach, the user is empowered with a fully functional and full-featured mobile personal computing and communications device, or module, which may be custom-configured by the addition of other modules, such as the peripherals and accessories, to meet such user requirements as may be dictated by circumstances or user preference.

The modules within as well as external to of the device 100 may be powered by a central battery, or two or more batteries may provides power to respective modules or groups of modules. For instance, the device 100 may have a small battery backup that keeps low level BIOS information, while the system would leverage a full scale battery for full power usage. The cellular communications module 104 may have a separate battery, or may also draw on the main battery. Solid state circuitry may be used to manage power requirements.

An illustrative embodiment of a mobile personal device 200 is illustrated in several perspective views in FIG. 2. The device 200 has on/off switch 201, and is housed within a casing 202 having a rubber overmold section 207 with molded texture 205 for secure handling. The device 200 has a screen 204 on one side, that may be a touch sensitive screen for displaying information to the user and for receiving information input from the user. A stylus 206, provided with the device 200, may be used for inputting information to the device 200 via the touch screen 204. The stylus 206 may be convertible into a pen for the user to use for writing. The device 200 may be provided with a built in microphone 208, with access holes through the casing 202 to receive audio signals at the microphone. The device may also include a speaker (not shown) for sending audio signals to the user. A media slot 203 may be provided for insertable/removable memory media such as Secure Digital (“SD”), SmartMedia, and Memory Stick.

The device 200 may also be provided with a protective cover 210 that may be placed over the screen 204 to provide protection when the device 200 is not in use, and that can be removed to reveal the screen 204 when the user desired to use the screen 204. In one embodiment, the cover 210 may be reversible, so that when it is not covering the screen 204, the cover 210 covers the backside of the device 200, as is illustrated in the inset in FIG. 2.

The device 200 may also have an electrical input 212 to receive electrical power from, for example, an AC adapter for operating, recharging, or both. The device 200 is also provided with a capability for external connections, such as, for example, peripheral devices, a network, and so forth. In the illustrated embodiment, such connectivity includes electrical connections 214 that may be used for wired connections such as, for example, a network connector for connection to a network, a video connector for connection to an external display screen, a keyboard connection for connection to an external keyboard, and so forth.

Alternatively, the connections 214 may be designed for connecting the device 200 to a customized docking station 302, an example of which is illustrated in several perspective views in FIG. 3. The docking station 302 may provide additional connectivity to input devices such as, for example, a keyboard, mouse, joystick and so forth via inputs 304, and to output devices such as monitors, printers and so forth, via outputs 306. The input and outputs 304 and 306 may be USB ports or any other suitable type of port. For example, a video port 308 may be used to connect to an external video monitor. The docking station 302 may also provide connectivity to a network via, for example, an Ethernet connection.

The docking station 302 may also be used for recharging the battery or batteries in the device 200. Consequently, the docking station 302 is provided with an input 310 to receive electrical power from, for example, an AC adapter. LED 303 indicates the power status of the device 200. As is illustrated, the docking station may advantageously orient the device 200 so that the user is able to view the screen 204, although this is not a necessary feature of the docking station 302.

FIG. 4 is an illustration of an alternative platform configuration of a mobile personal device 400 that has a split onboard keyboard. The device 400 has cooling vents 410 and a foldable GSM antenna 428 along a top edge, a headset jack 440 and a power button 442 along a left edge, and a phone power button 460 and a one inch LCD phone screen 430 along a beveled portion 454 of the right edge. The bottom edge of the device 400 includes a charging jack 450, a docking connector 452, a cooling fan 456, and two USB connectors 458. A front face of the device 400 includes a mouse navigation pad 420, LED indicators 422 for power and other device status information, speaker and microphone vents 424, left and right buttons 426 configurable for use with the mouse pad 420, and a five inch LCD main display screen 434. The front face of the device 400 also includes a split keyboard having right and left sections 436 and 432.

FIG. 5 is an illustration of an alternative platform configuration of a mobile personal device 500 that has a unitary onboard keyboard 532 and an internal GSM antenna 528. Otherwise, the device 500 is substantially identical to the device 400.

Particularly because of the mobile nature of the mobile personal device, security features are highly desirable, if optional. The mobile personal device may include any combination of physical and software security features, including one or more of the following: U-Bolt anchoring feature; padlock support (user supplied lock); diskette I/O control; hardfile I/O control; parallel port I/O control; serial port I/O control; power on password; configuration password; diskette Boot inhibit; boot sequence control; boot without keyboard or mouse; system serial number, machine type and model; IBM Security Slot; supervisor password; and hard disk drive password. Security as well as device personalization may also be obtained by using well known security protocols developed around the subscriber identity module (“SIM”), which is a standard component of the mobile station of a Global System for Mobile Communications (“GSM”) network architecture. When GSM-capable, the cellular communications module 104 contains a SIM card, which is thereby available to the processor module 102 of the mobile personal device for security functions and personalized services. Utilizing techniques known for stand-alone cell phones, the mobile personal device may include the International Mobile Equipment Identity (“IMEI”) which uniquely identifies the device, and the SIM card may include the International Mobile Subscriber Identity (“IMSI”) which uniquely identifies the subscriber. The IMEI and the IMSI are independent, thereby allowing personal mobility, while the SIM card includes a secret key for authentication, a user password or identity number, and other information to protect against unauthorized use.

Improved user security may be achieved through more advanced techniques, including biometrics such as fingerprint identification, retinal scan identification, voice recognition, and biological sampling identification. Biometrics may be used in association with or instead of SIM-based security. Biometrics sensors are generally useful for identifying persons, whether for security or other applications.

Security may be established at different levels. The highest level of security may be reserved for the user. A low level of security may be provided whereby any user may operate the mobile personal device to make emergency calls or to display contact information for returning a lost device to its owner. Security may be set to allow certain third parties limited access to particular information stored on the mobile personal device, such as to permit authorized medical and emergency personnel access to vital medical information about the user stored on the mobile personal device.

While any type of display screen having compatible size and power requirements may be used in the mobile personal device, a type of display well suited for use is a 4-inch color side light low-temperature polysilicon (LTPS) thin-film transistor (TFT) liquid-crystal display (LCD) with 202 pixels per inch (ppi) VGA (640×480) resolution. One source of such a type of display is the Toshiba 200 ppi-series of products, such as model LTM04C387S. This display offers a bright, vivid display of many colors, the result of an integrated reflective electrode and the adoption of a single polarizer for enhancing contrast ratio. The glass substrate in Toshiba's LTPS TFT LCD technology supports faster electron flow than the non-crystallized substrate used in mainstream amorphous-silicon TFT LCDs. This performance enhancement allows most LCD drivers to be formed within the display itself, not externally. As a result, the space required at the periphery of the panel is minimized, the number of components in the LCD module cut by 40 percent. In addition, the number of connections between TAB drivers and electrodes on the panel is reduced by 95 percent. This simpler design fosters greater reliability and displays offering higher resolution, richer color and more design flexibility than other LCDs.

The next-generation wireless handsets and mobile terminals will support transmission of high-quality motion pictures and improved sound. MPEG-4, a recently established video compression technology, is specifically designed for wireless video transmission and is expected to become a key element of such services. As a result, demand is growing for brighter, high-resolution displays that consume as little power as possible while offering high resistance to shock and vibration. This display has been developed expressly to meet these demands and offer the features essential for mobile products. The mobile personal device may support MPEG-4 standard motion picture communications.

Specifications of a suitable illustrative LCD display panel, the model LTM04C387S panel, is now presented: Pixel count—640×480 pixels (VGA); Pixel pitch—0.126×0.126mm (202 ppi); Display size—4 inches (10 cm diagonal); Glass Size—94.04 (W)×69.98 (H); Gradation—64 gray scale/260,000 colors; Power consumption—1.1 W; Response time—ton+toff=100 ms; Contrast ratio—250:1; Brightness—200 cd/m2; Weight—65 g.

The mobile personal device is provided with cellular communications capabilities. Useful cellular communications modules include model MC45 which is available from Siemens Information and Communication Mobile Group of San Diego, Calif., and model P5186 which is available from Wavecom Inc. of San Diego, Calif. The cellular communications module may be a GSM module, or may be any other suitable type of cellular module that adheres to any of the different telecommunications standards around the globe. The cellular module may also be GPRS (General Packet Radio Service) compliant (class 10 or other class as desired), advantageously making it possible to achieve faster connections than a traditional dialup home connection.

The model MC45 module has tri-band technology that supports global GSM networks in the frequency ranges 900, 1800 and 850, while the model P5186 module has quad-band technology that supports global GSM networks in the frequency ranges 850-1900 MHz and can therefore be used throughout the world. The model P5186 module in particular offers users worldwide access to the Internet, corporate Intranet and email services through remote means.

Besides fast data transmission via GPRS, the cellular module may also support the receipt and transmission of faxes and short messaging services (SMS), cell broadcast services and voice communication. Via the audio interface, the integrated microphone/loudspeaker of the mobile personal device may be activated and used as a hands-free system for telephone calls.

The cellular module may have an efficient digital dual interface that allows the simultaneous transmission of data and control of device functions via a standardized command set. This makes the module quick and easy to integrate into the system architecture of mobile terminals and also allows the end user to use commercially available communication software.

Any suitable microprocessor may be employed in the processor module 102. The microprocessor preferably and advantageously provides full software application functionality in the mobile personal device, permitting the user to use common business application software, for example Microsoft Office applications and the like.

Different instruction execution times (in cycles) make it difficult to compare systems based purely on clock speed or number of cycles per second. A single cycle is the smallest element of time for the processor. Every action requires at least one cycle, and usually more. To transfer data to and from memory needs, for example, in a modern processor such as a Pentium II made by Intel Corp., a minimum of three cycles to set up the first memory transfer and then only a single cycle per transfer for the next three to six transfers. The extra cycles on the first transfer are normally called wait states. A wait state is a clock tick in which nothing happens, to ensure that the processor is not getting ahead of the rest of the computer.

The time required to execute instructions varies. The Pentium family of microprocessor chips manufactured by Intel Corp. includes twin instruction pipelines and other improvements that provide for operation at two or more instructions per cycle. Advanced members of the Pentium family, such as the Pentium Pro and the Pentium II can execute as many as three or more instructions per cycle. Accordingly, with clock speeds in excess of 1 GHz, modern full processors are capable of performing in excess of two billion instructions per second.

In one particular embodiment, the microprocessor module includes a Pentium M (Dolthan) processor in a Centrino package running at a slower clock frequency than in previous-generation mobile processing technology. Most notebook vendors, for example, had 2.4 GHz Pentium 4-M systems in their lineups, whereas many of the new Centrino-based notebook processors clock in at 1.6 GHz. Frequency does not significantly affect performance, however, where the processor module includes sufficient caches and accurate branch prediction. In tests, the Centrino-based processor outperformed the higher-frequency, power-hungry devices. For example, the Centrino chip set performed 13% faster in the BAPCo MobileMark 2002 benchmark testing, compared with a conventional processor having the same clock speed, while improving battery life by 23%.

The following list provides some of the features of one embodiment of a suitable processor. While providing advantageous operational characteristics, it will be appreciated that these features are not all necessary to the successful operation of the mobile personal device. The features are: support for Intel® Architecture with Dynamic Execution; a high performance, low-power core; an on-die, primary 32-kbyte instruction cache and 32-kbyte write-back data cache; an on-die, 1-MByte second level cache with Advanced Transfer Cache Architecture; an advanced Branch Prediction and Data Prefetch Logic; streaming SIMD Extensions 2 (SSE2); a 400-MHz, Source-Synchronous processor system bus; advanced power management features that include Enhanced Intel® SpeedStep® technology; and micro-FCPGA and Micro-FCBGA packaging technologies.

A factor for consideration in the mobile personal device is thermal management of the processor module. This brings about a consideration of at least the following: reduction of heat generated in the processor module 102, and efficient removal of heat from the processor module 102. A high performance processor core is preferred, and may include architectural innovations like Micro-op Fusion and Advanced Stack Management, that reduce the number of micro-ops handled by the processor module. This results in more efficient scheduling and better performance at lower power. An active cooling agent, such as, for example, a fan, is used to moderate device temperature within specification during high performance activity.

The processor module may also feature a branch prediction architecture that significantly reduces the number of mispredicted branches. For example, the processor's Data Prefetch Logic speculatively fetches data to the L2 cache before an L1 cache requests occurs, resulting in reduced bus cycle penalties and improved performance. The Streaming SIMD Extensions 2 (SSE2) enable break-through levels of performance in multimedia applications including 3-D graphics, video decoding/encoding, and speech recognition. The new packed double-precision floating-point instructions enhance performance for applications that require greater range and precision, including scientific and engineering applications and advanced 3-D geometry techniques, such as ray tracing. The Intel Pentium M processor's 400-MHz processor system bus utilizes a split-transaction, deferred reply protocol.

The 400-MHz processor system bus uses Source-Synchronous Transfer (SST) of address and data to improve performance by transferring data four times per bus clock (4× data transfer rate, as in AGP 4×). Along with the 4× data bus, the address bus can deliver addresses two times per bus clock and is referred to as a “double-clocked” or 2× address bus. Working together, the 4× data bus and 2× address bus provide a data bus bandwidth of up to 3.2 Gbytes/second. The processor system bus uses Advanced Gunning Transceiver Logic (AGTL+) signal technology, a variant of GTL+signaling technology with low power enhancements. The processor features Enhanced Intel SpeedStep technology, which enables real-time dynamic switching between multiple voltage and frequency points instead of two points supported on previous versions of Intel SpeedStep technology. This results in optimal performance without compromising low power. The processor features the Auto Halt, Stop-Grant, Deep Sleep, and Deeper Sleep low power states.

The Intel Pentium M processor utilizes socketable Micro Flip-Chip Pin Grid Array (Micro-FCPGA) and surface mount Micro Flip-Chip Ball Grid Array (Micro-FCBGA) package technology. The Micro-FCPGA package plugs into a 479-hole, surface-mount, Zero Insertion Force (ZIF) socket, which is referred to as the mPGA479M socket.

The new mobile-optimized microarchitecture delivers higher performance and lower power consumption to enable longer battery life in today's mainstream systems. Key features include: Micro-Ops Fusion, which combines two micro-operations into one, enabling it to execute faster and at lower power; Advanced Branch Prediction—a new implementation technique—to help to reduce overall latency in the system contributing to higher performance at lower power; and the Dedicated Stack Manager, which reduces the overall number of micro-operations required to generate higher performance at lower power.

The Intel 855 chipset family includes two new chipsets developed exclusively for the mobile market segment, the 855PM supporting discrete graphics and 855GM with integrated Intel® Extreme Graphics 2 technology. The new chipsets also support Enhanced Intel SpeedStep technology, Deeper Sleep Alert State and an internal timer that automatically turns off the chipset clock when the chipset is inactive. The 855GM chipset also includes a low-power graphics power management mode. Both chipsets include a 400 MHz processor system bus and support for up to 2GB of DDR 266 memory, along with support for USB 2.0 and Intel's I/O Hub Architecture.

Measuring Mobile Performance And Battery Life as measured by MobileMark™ 2002, the industry's first benchmark testing a combination of battery life and performance, Intel Centrino mobile technology-based systems may deliver up to five hours of battery life or more, compared to about four hours on mobile Intel® Pentium® III processor-M-based system and about 3 hours on mobile Intel® Pentium® 4 processor-M-based systems. On the same benchmark, Intel Centrino mobile technology offers 41 percent faster performance on multitasking office productivity applications compared to a mobile Intel Pentium III processor-M 1.2 GHz, and a 15 percent improvement compared to the mobile Intel Pentium 4 processor-M 2.4 GHz system. In addition, users of Intel Centrino mobile technology based-systems will find 59 percent better performance in their Internet experience as measured by the WebMark* benchmark when compared to the mobile Intel Pentium III processor-M 1.2 GHz and a 13 percent improvement gain when compared to the mobile Intel Pentium 4 processor-M 2.4 GHz.

Intel Centrino mobile technology includes a new mobile processor, related chipsets and 802.11 wireless network functions that have been optimized, tested and validated to work together. In addition to wireless communications, Intel Centrino mobile technology includes features designed to enable extended battery life, thinner and lighter devices, and outstanding mobile performance.

The mobile personal device includes the wireless interface 110 for off-device communications. One example of a wireless interface is the Intel PRO/Wireless 2100 Network Connection. In one embodiment, the wireless interface may be designed and validated to connect to 802.11 abg Wi-Fi certified access points. The wireless interface may also support advanced wireless LAN security including, for example, 802.1x, WEP and VPN technologies, and be software upgradeable to support WPA. The processor module may also be wireless compatible with communications network interfaces so as to be able to connect to networks. The mobile personal device is particularly suitable for use with forthcoming wireless standards, such as, for example, the Worldwide Interoperability for Microwave Access (“WiMAX”) standard based upon IEEE 802.16, which is expected to be available in the second half of 2005.

The Intel PRO/Wireless 2100 network connection has been verified with leading VPN (virtual private network) suppliers. The wireless card is also available with Intel® PROSet Software, which offers many ease-of-use and low power features. It also supports a technology that reduces interference with 802.11 signals and certain Bluetooth™ devices.

The mobile personal device may support low power operation of the microprocessor. Low power mode may be used to run applications that are not computationally intensive yet are desired to be active for long periods of time, such as applications that provide reminders to the user of various scheduled events.

To support aggressive power management, the mobile personal device may have a wake-up-on-LAN capability so that the microprocessor may enter into a sleep mode from which it is awaken if traffic is detected on a wireless or wired network. In addition, the cell phone remains powered-up and capable in particular modes of waking the microprocessor so that incoming calls may be handled by the microprocessor in a manner desired by the user. The mobile personal device may thereby conserve power without sacrificing the ability to manage communications of all types, including voice, email, instant messages, transactions, and data.

The mass data storage device is preferably compact and has low power requirements. One example of such a device is a 1.8-inch embedded HDD available from Toshiba. This is a mini-drive giving significant storage for operating system and applications. The related technical specifications are as follows: 1.8″ sized drive; lightweight, 62 grams; Low Power Consumption; 2 Platter; 40.0 Gigabytes; 8 mm High; 15 ms Average Seek Time; 100MB/s Ultra DMA Transfer Rate; ATA (2-5) Interface Ultra DMA 100; 512 KB Buffer; Rotational speed of 4,200 rpm; and MTTF 300,000 Hours.

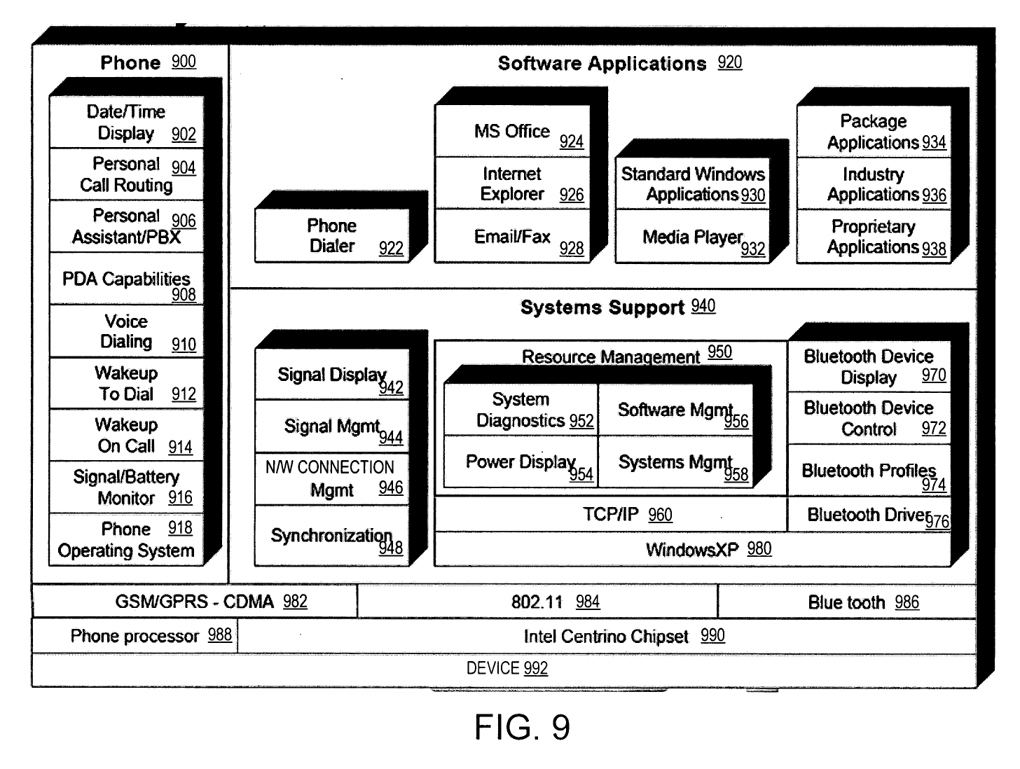

FIG. 9 is a schematic block diagram of an illustrative architecture for a mobile personal device. The phone components 900 include date time display 902, personal call routing 904, personal assistant and PBX 906, PDA capabilities 908, voice dialing 910, wakeup to dial 912, wakeup on call 914, signal and battery monitor 916, and phone operating system 918. The software applications 920 include a phone dialer 922, MS Office 924, Internet Explorer 926, email and fax 928, standard windows applications 930, media player 932, package applications 934, industry applications 936, and proprietary applications 938. System support components 940 include signal display 942, signal management 944, network connection management 946, synchronization 948, Bluetooth device display 970, Bluetooth device control 972, Bluetooth profiles 974, Bluetooth driver 976, various resource management components 950, and TCP/IP 960, all running on top of Windows XP 980. The resource management components 950 include system diagnostics 952, power display 954, software management 956, and systems management 958. Various other software components include GSM/GPRS and CDMA support 982, 802.11 support 984, Bluetooth device support 986, phone processor support 988, microprocessor support 990, and device support 992.

Connections and Communications Management

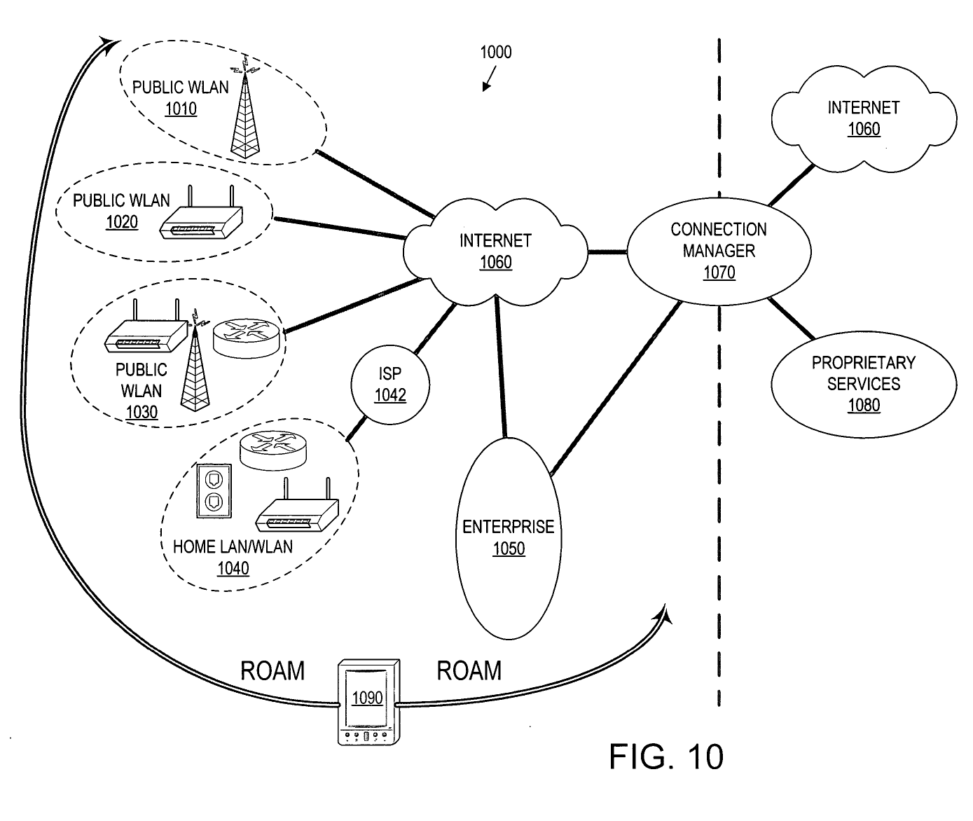

FIG. 10 is a schematic diagram of a network architecture 1000 built around a non-private network connection manager 1070. The network 1000 includes many other networks, public and private, yet is secure and is able to maintain persistence, authentication and encryption across various network boundaries because of the connection manager. The mobile personal device 1090 roams seamlessly from network to network, without any need to login and re-initialize the running applications when roaming occurs.

To provide seamless roaming, the connection manager 1070 is provided with suitable software such as WebSphere® Everyplace™ Connection Manager available from IBM Corporation of Boca Raton, Fla., and disclosed in a brochure by IBM Pervasive Computing, WebSphere Everyplace Connection Manager: increasing mobile security, reducing wireless costs, IBM Corporation, April 2003. Seamless roaming is the ability to maintain the current state and security of an end-user session, even if the mobile device changes networks. Persistence allows switching physical networks, while preserving both the VPN connection and application session. In the WebSphere Everyplace Connection Manager, roaming is accomplished via a software layer that isolates the application from the physical network interface, implements a persistent IP network interface, and routes application traffic through that new interface. This permits the mobile personal device VPN to dynamically select networks and smoothly roam without breaking session integrity. Roaming across multiple networks including non-IP pack radio networks is possible.

As shown in FIG. 10, the mobile personal device 1080 is able to operate seamlessly from the secure or non-secure home through public spaces to the secure enterprise. The home environment illustratively has a wired and wireless LAN 1040 connected to the connection manager 1070 through an Internet Service Provider (“ISP”) 1042 and the Internet 1060. The mobile personal device 1090 may either plug into the wired LAN segment of the network 1040, or wirelessly connect to the wireless segment of the network 1040. When the user leaves the home, the mobile personal device 1090 roams and securely and seamlessly reconnects to the connection manager 1070 through either public WLAN 1030, which is both a Wi-Fi hotspot and a wireless wide area network using TDMA, CDMA, GPRS, 3-G, satellite, packet radio, and so forth; or through public WLAN 1020, which is both a Wi-Fi hotspot; or through public WLAN 1010, which is a wireless wide area network using CDMA, GPRS, 3-G, satellite, packet radio, and so forth. When the user arrives at the enterprise, the mobile personal device 1090 roams and securely and seamlessly reconnects to the connection manager 1070 through the enterprise's Internet connection. The enterprise 1050 may connect to the Internet 1060, the connection manager 1070, or to both.

A client or other software running on the mobile personal device 1090 cooperates with an IP address proxy in the connection manager 1070 to provide session integrity. When the user requests a particular URL, the client routes the ULR request to the connection manager 1070 rather than to the addressed web site. The connection manager 1070 then forwards the request to the addressed web site using an IP address proxy or to proprietary services 1080, receives the reply packets, and routes the reply packets to the current IP address of the mobile personal device 1090. As the mobile personal device 1090 roams and registers on a new network, it informs the connection manager of the new registration so that the connection manager can correctly route any outstanding reply packets.

Security is of great concern to customers. Corporations have a strong interest in securing the transmission of private data not only outside the confines of their internal networks, but also inside the confines of their network. For optimal security, the connection manager 1070 provides a secured connection with the mobile personal device 1090 whether the connectivity is with a public WLAN such as 1010, 1020 and 1030, a home WLAN such as 1040, a corporate network such as 1050, or other supported connections. When a connection is started, it is initially unsecured. The connection manager 1070 initially negotiates with the mobile personal device 1090 to authenticate the identity of this device and its user. Once the identity is authenticated, a secured connection is initiated and maintained through the session. The mobile personal device 1090 is, then, able to access any internal corporate, external, or publicly accessible sites in either a secure manner or a non-secure manner, as desired. For secure access to a website, the connection manager 1070 initiates and maintains a secure connection with the website for as long as the user so directs. If a website does not require or allow secure access, the connection between the device 1090 and the connection manager 1070 preferably is secure even though the connection between the connection manager 1070 and the website may not be secured. In this case, the connection manager 1070 acts as a conversion point, a security proxy, to allow access to insecure sites. In addition, a secure, private connection from the connection manager 1070 to the enterprise 1050 may be implemented.

Authentication of identity of the mobile personal device 1090 and of its user may be performed through multiple means. This increases the probability that a positive identity is correct. Mechanisms to determine identity include user id and password and utilizing the SIM card. This SIM card, as described elsewhere, contains information specific to the device ownership. This is then utilized by both the cell phone communications and the computer functionality. The computer software applications query the SIM card to obtain identity data. This is then used by the connection manager 1070 to assist in determining identity. The SIM information is not transferred on the network, but is used to generate a public key that is then transmitted over a secure connection to the connection manager 1070. The connection manager 1070 ensures that the key it received is compatible with the key it has generated. A positive match results in a secure connection being setup to provide ongoing connectivity. A negative match results in the secure connection not being setup and notification of this being sent to the mobile personal device 1090.

The connection manager 1070 may be part of a Mobile Virtual Network Operator (“MVNO”). While the user of a mobile personal device may subscribe or otherwise have access to voice and data service from different providers, it is preferable for the user to have integrated wireless voice and data services provided by a primary service provider. The primary provider may act as a reseller for one or more selected network carriers. Users benefit from dealing with one service provider for the purchase, implementation and on-going support for a complete mobile information solution.

Global wireless subscriber penetration rate is expected to double by the year 2008. There are currently six national wireless carriers and numerous regional carriers which make up a bulk of the available market. These companies are competing fiercely for customers by offering “bundles” of low cost service plans. Because of this extreme price competition, these vendors experience a high rate of customer turnover. It is estimated 35 percent of all cell phone subscribers change their service provider each year trying to obtain better pricing or service.

Wireless service resellers or MVNOs have the potential to capture a significant share of the wireless services market. A reseller advantageously has the capability to capture a significant group of subscribers with their primary product or solution. A group of similar subscribers may be offered a specific vendor's service “bundle” based on their wireless connectivity needs and budget. This business model can be viewed as both complementary and competitive to existing mobile wireless operators. Although wireless service resellers first emerged in Europe, they are becoming popular also in the United States.

The built-in wireless network capabilities for both voice and data services and multiple voice and data network roaming with the mobile personal device creates a group of similar subscribers. Since each mobile personal device user will more than likely desire wireless network services, a wireless service reseller may, as a MVNO, provide integrated wireless services to the device users.

MVNOs also have multiple sources of additional revenue. The market for premium data services (which include services beyond voice delivery) includes downloading games, music, and other forms of entertainment, is predicted to generate significant revenues in the future. For example, the build-out and interconnection of high-speed, wireless LANs (also called Wi-Fi hot-spots) is expected to create the foundation for delivering these premium services. The delivery of these additional value-added services will add incremental revenue and profit margin to the bottom line.

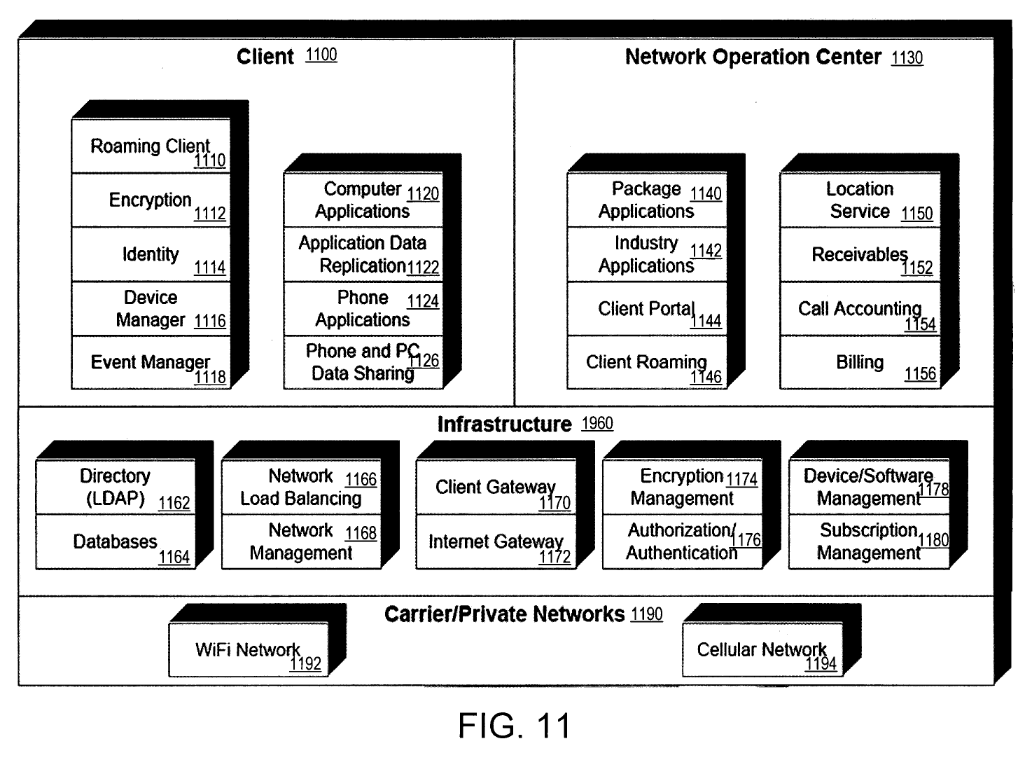

FIG. 11 is a schematic block diagram of an illustrative software architecture for an MVNO. A client 1100 includes the following components: a roaming client 1110, encryption 1112, identity 1114, a device manager 1116, and an event manager 1118. A network operation center 1130 includes package applications 1140, industry applications 1142, client portal 1144, client roaming 1146, location service 1150, receivables 1152, call accounting 1154, and billing 1156. Infrastructure 1160 includes directory (LDAP) 1162, databases 1164, network load balancing 1166, network management 1168, client gateway 1170, internet gateway 1172, encryption management 1174, authorization authentication 1176, device and software management 1178, and subscription management 1180. Carrier and private networks 1190 include WiFi network 1192 and cellular network 1194.

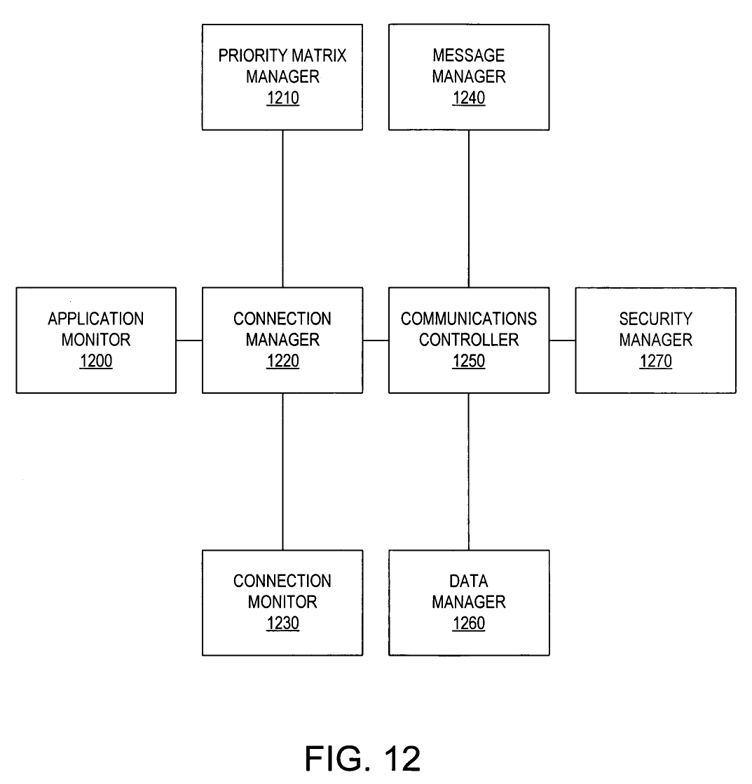

To take maximum advantage of seamless networking that is able to maintain security, persistence, authentication and encryption across various network boundaries, the mobile personal device performs sophisticated connections management and communications management. FIG. 12 is a block schematic diagram showing an overview of an illustrative connections and communications management architecture. A communications controller 1250 and a connection manager 1220 are in communication with one another. The connection manager 1220 obtains connection priority information from a priority matrix manager 1210, connection availability and status information from a connection monitor 1230, and communication activity requirements of the user from an applications monitor 1200. The connection manager 1220 evaluates the types of communication networks available at any given time and the services associated with each available network, as well as the communication activity that is being used and likely to be required by the user. Then based upon a user connection priority matrix, the system determines which available network is most desirable.

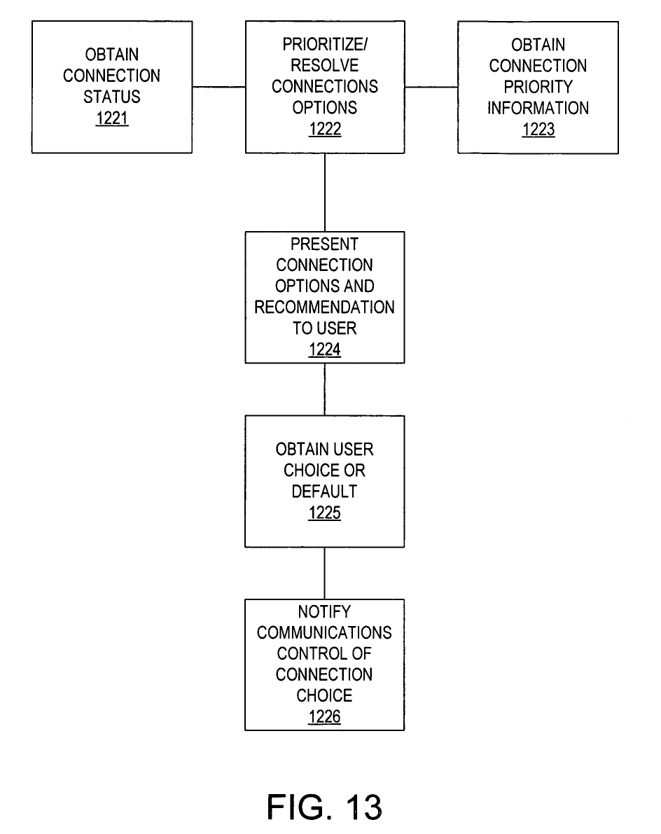

FIG. 13 is a block schematic diagram showing various functions carried out by the connection manager 1220. The connection manager 1220 obtains connection status data (block 1221) and obtains connection priority data (block 1223). The connection priority data is obtained either in default form or the user may establish the parameters. If the default connection priority data is used, the user may modify the default forms and add new connection priority parameters. The connection manager 1220 then prioritizes and resolves the available connection options (block 1222). The connection manager may then present connection options and recommendations to the user (block 1224), who may choose the desired connection option. The connection manager 1220 thereupon notifies the communications controller 1250 of the connection choice (block 1226). In the absence of a user election of a connection option, the best available connection will be selected based upon the priority parameters and rules provided in the user connection priority matrix.

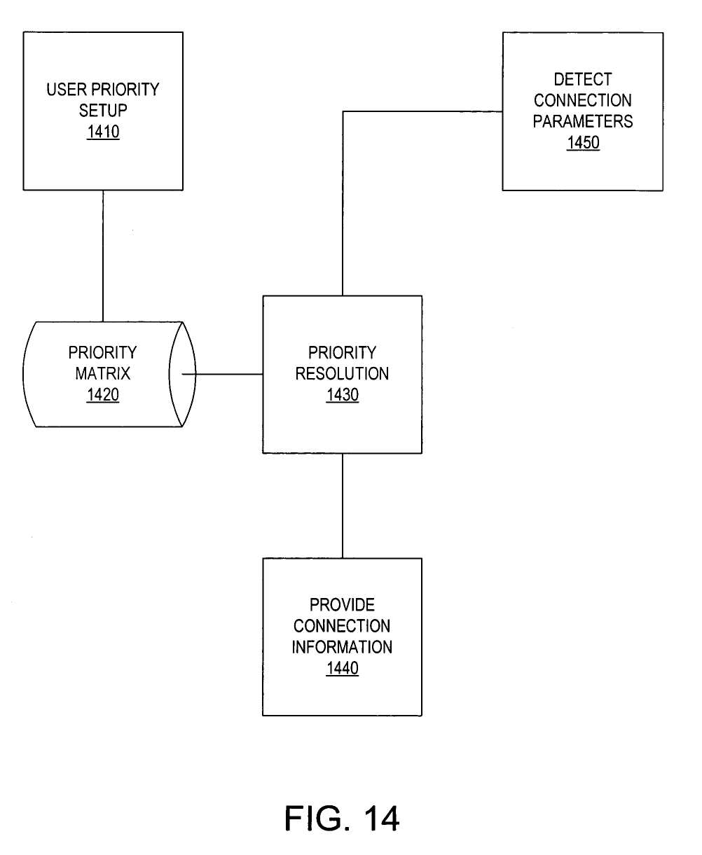

FIG. 14 is a block schematic diagram showing various detailed functions for prioritizing and resolving connections options (block 1222 of FIG. 13). Default priority rules may be used, or the user may set up new priority rules or modify the default rules (block 1410), which results in a priority matrix 1420. Connection parameters are evaluated (block 1450) and compared against the rules contained in the priority matrix 1420 to resolve connection priority (block 1430). Upon resolution of the connection priority, the appropriate connection information is provided (block 1440).

An example of a priority matrix 1420 that may be utilized to manage the network connections of the mobile personal device is shown in TABLE 3.

TABLE 3

| CONNECTION TYPE | QUALITY | SPEED | RELIABLE | COST | SECURITY |
|---|---|---|---|---|---|
| DEFAULT WIFI | M | H | M | L | L |
| DEFAULT CELL PHONE | M | M | M | H | M |
| DEFAULT WIRED | H | H | H | L | H |
| T-MOBILE WIFI | H | H | H | M | M |
| HOME WIFI | H | H | H | L | M |
| CORPORATE WIFI | H | H | H | L | M |
| CELL PHONE ROAM | M | L | L | VH | M |

Essentially, the priority matrix provides connection parameters that may include, inter alia, quality of the connection, connection speed, connection reliability, cost of the connection and connection security. Default network connections that may be provided include Wi-Fi, Cell Phone and Wired networks. Additional connections in the example include Home Wi-Fi, the enterprise or corporate Wi-Fi, and cell phone roaming. Each network connection parameter is either qualitatively or quantitatively graded for each network connection. In the example the following gradations are used: (L) low; (M) medium; (H), high; and (VH) very high. Thus, for the default Wi-Fi network connection shown in the example matrix, the quality is medium (M), speed is high (H), reliability is medium (M), cost is low (L) and security is low (L). With the basic connection priority matrix thus established, one or more of the listed connections may be more attractive for given uses than others.

In addition, it may be desirable for the user to attach weightings to one or more of the connection parameters to assist in determining which of the network connections to select in a given situation. In certain situations, the user may place reliability above all other parameters, including cost. Thus, the user may further inform the priority matrix by appropriately weighting one or more of the connection parameters. This allows the user to determine, for a given situation, which of the connection parameters are most important. These weightings are illustrated in TABLE 4, which shows the example priority matrix adjacent the relevant connection parameter. In the example, quality and reliability are most important with weightings of “1” and cost is least important with a weighting of “3.” Ultimately, the best available network is either selected by the system or the user elects a different network in order to serve a particular need.

TABLE 4

| PARAMETER | PRIORITY |
|---|---|
| QUALITY | 1 |
| SPEED | 2 |
| RELIABILITY | 1 |
| COST | 3 |
| SECURITY | 2 |

Once the incoming connection parameters are detected (block 1450), the connection priority is resolved (block 1430) based upon the priority matrix 1420, and the connection priority information is provided.

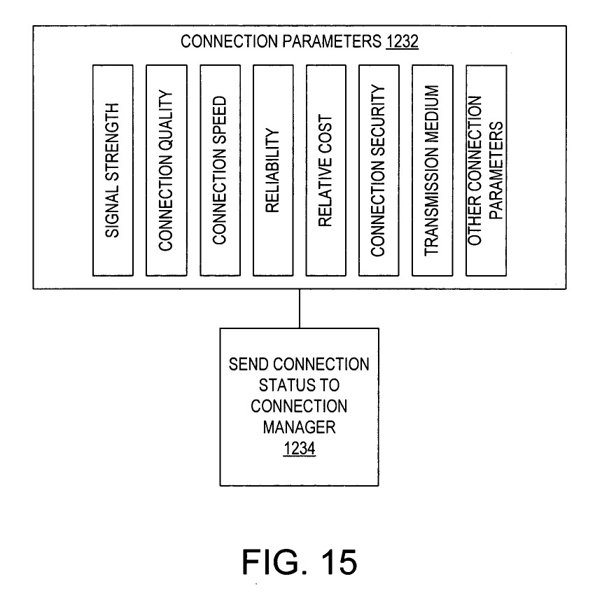

FIG. 15 is a block schematic diagram showing various detailed functions carried out by the connection monitor 1230. The connection monitor 1230 examines various connection parameters 1232 such as, for example, signal strength, connection quality, connection speed, reliability of the connection, relative cost, connection security, the transmission medium, as well as other relevant parameters. The status of these connection parameters is then provided to the connection manager 1220 for evaluation (block 1234).

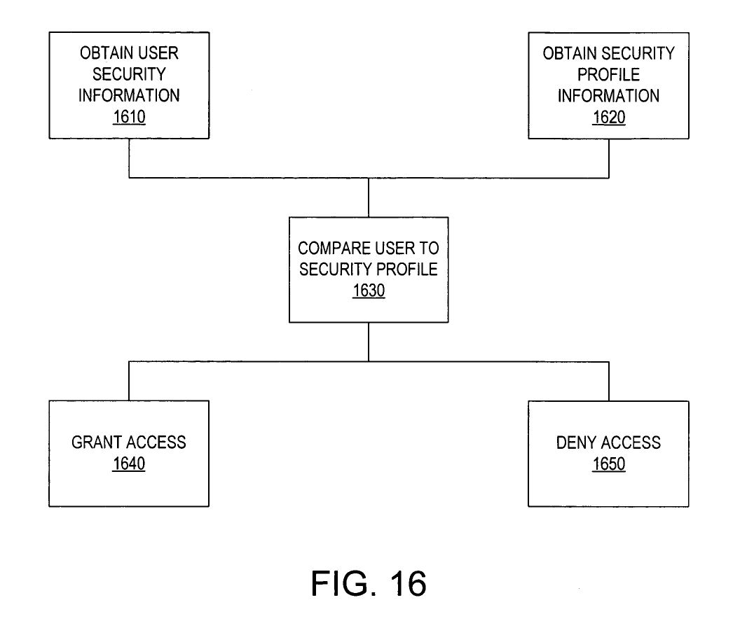

FIG. 16 is a block schematic diagram showing various detailed functions carried out by the security manager 1270. Security information stored in preferably encrypted form on the mobile personal device (block 1620) and security information acquired from the user (block 1610) are compared (block 1630), and a determination is made whether to grant access (block 1640) or deny access (block 1650). Many types of user security information may be used depending on the level of security desired, and includes passwords, keycards, fingerprint identification, retinal scan identification, biological sampling identification, and so forth.

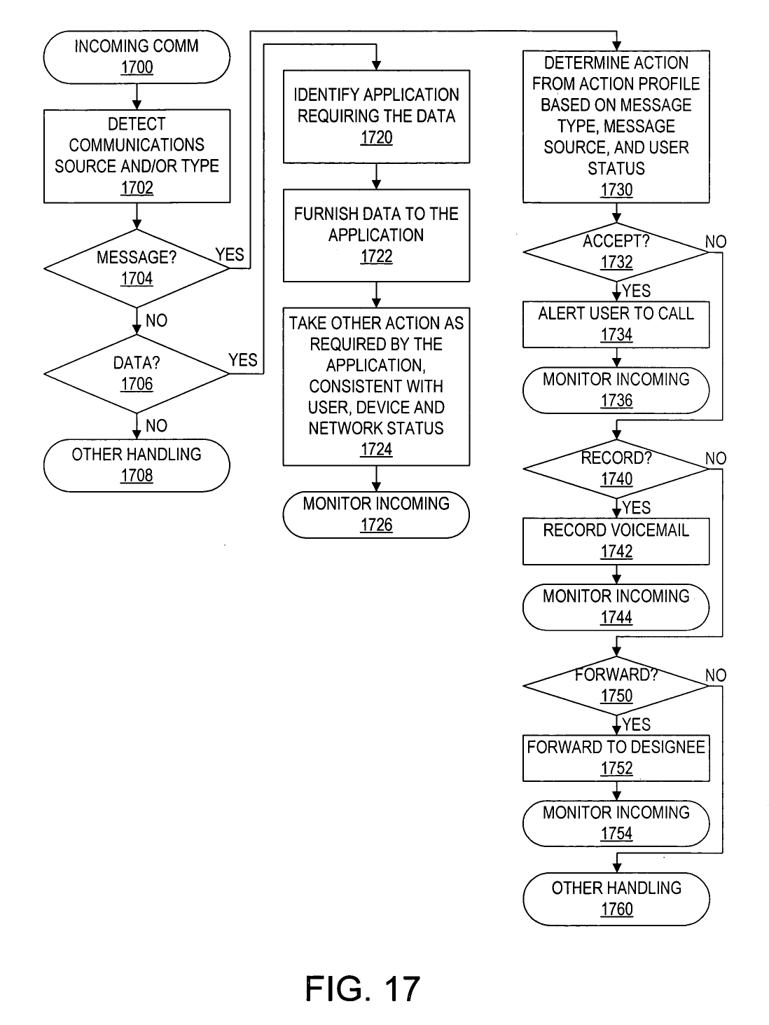

FIG. 17 is a flowchart of an illustrative process 1700 for handling a variety of different communications types. The communication source and type are detected (block 1702). Primary types are messages and data, which are handled somewhat differently by the communications controller 1250. Messages include various types such as instant messages, email, voicemail, transactions, and voice calls, and are handled by a message manager 1240 (FIG. 12). Data includes pushed and pulled data, streaming data such as audio and video, collaboration data, various file types, and so forth, and is handled by a data manager 1260 (FIG. 12).

If the communications is a message (block 1704—yes), the desired action is determined from an action profile based on message type, message source, and user status. An illustrative action profile is shown in TABLE 5, in which permitted actions are to accept the message (indicated by “Y”), to record the message by forwarding to voicemail (indicated by “VM”), and to forward the message to a designate (indicated by “F”). If the message is accepted (block 1732—yes), the user is alerted to receipt of the message (block 1734) and the process 1700 returns to monitoring incoming communications (block 1736). If the message is to be recorded (block 1740—yes), the user is recorded in memory (block 1742) and the process 1700 returns to monitoring incoming communications (block 1744). If the message is to be forwarded (block 1750—yes), the message is forwarded to the designate (block 1752) and the process 1700 returns to monitoring incoming communications (block 1754).

TABLE 5A
INSTANT MESSAGING MATRIX

| | Boss | Person1 | Group1 | Group2 | No Group |
|---|---|---|---|---|---|
| Available | Y | Y | Y | Y | Y |
| Meeting | Y | F | F | VM | VM |
| Unavailable | F | F | VM | F | VM |
| Vacation | Y | F | F | F | F |
| At Home | VM | Y | F | Y | VM |

TABLE 5B
EMAIL MATRIX

| | Coworkers | Group1 | Person1 | Family | Unknown |
|---|---|---|---|---|---|
| Available | Y | Y | Y | Y | VM |
| Meeting | Y | F | F | Y | VM |
| Unavailable | F | F | VM | Y | VM |
| Vacation | F | VM | VM | Y | VM |
| At Home | F | Y | Y | Y | VM |

TABLE 5C
VOICEMAIL MATRIX

| | Boss | Person1 | Group1 | Family | Blocked | Caller ID |
|---|---|---|---|---|---|---|
| Available | Y | Y | Y | Y | VM | Y |
| Meeting | Y | F | F | Y | VM | F |
| Unavailable | VM | VM | VM | VM | VM | F |
| Vacation | Y | F | F | Y | Y | Y |
| At Home | Y | Y | Y | Y | VM | Y |

TABLE 5D
TRANSACTIONS MATRIX

| | Corporate | System Backup | Personal | Financial |
|---|---|---|---|---|
| Available | Y | Y | Y | Y |
| Meeting | Y | Y | Y | Y |
| Unavailable | Y | Y | Y | Y |
| Vacation | Y | Y | Y | Y |
| At Home | Y | Y | Y | Y |

TABLE 5E
VOICE CALLS

| | Boss | Person1 | Group1 | Family | Blocked | Caller ID |
|---|---|---|---|---|---|---|
| Available | Y | Y | Y | Y | VM | Y |
| Meeting | Y | F | Y | Y | VM | F |
| Unavailable | Y | VM | Y | VM | VM | F |
| Vacation | Y | F | Y | Y | VM | Y |
| At Home | Y | F | F | Y | VM | Y |

If the communication type is data, the communications controller 1250 detects which application is waiting for the data (block 1720), furnishes the data to the application (block 1722), and takes such other action as required by the application, consistent with device, user and network status (block 1724). The process 1700 returns to monitoring incoming communications (block 1726).

The functionality to answer (or use in the case of data), store or forward a voice or data call is available either manually or automatically. In the manual mode, the current state (i.e. in a meeting, on vacation, etc.) is set by the user as needed. In automatic mode, the user's calendar is used to identify the appropriate profile to invoke based upon the appointment. For example, a meeting will invoke the “in a meeting” profile and a vacation will invoke the “on vacation” profile. A corporate holiday will invoke an appropriate profile. When no meeting is scheduled, during work hours the work profile will be used. This functionality is available for voice, messages, transactions, and other incoming or outgoing voice and data.

In a more general and powerful sense, communications management includes the functionality of establishing identifiable triggers to initiate autonomous execution of processes and applications, as well as commands that may in turn trigger other processes, applications and commands. The identifiable triggers may include any of a variety of different events, such as calendar events, emails, instant messages, notifications and outputs from running processes and applications, meta-data and html text in browser applications, and so forth. The triggers may be identifiable by any desired technique, including, for example, keyword identification, use of special characters in the triggers, direct links from running processes and applications to other processes and applications, and so forth.

An example of how identifiable triggers may be used to initiate autonomous execution of processes, applications and commands is as follows. A clinical physician typically has several patient appointments scheduled by an assistance. Generally, prior to the appointment, the physician reviews the patients' medical records. With current technologies, this requires the physician to search either paper or electronic record systems for the patients' information. Using a centralized computer, the doctor reviews the records and then leaves to see the patient where the medical records are again retrieved. A mobile personal device may recognize that the physician is scheduled to see a particular patient. It then initiates and monitors the autonomous retrieval of the patients records and notifies the physician when the information is available. The physician may then review the medical records on his mobile personal device and bring the mobile personal device to the patient appointment.

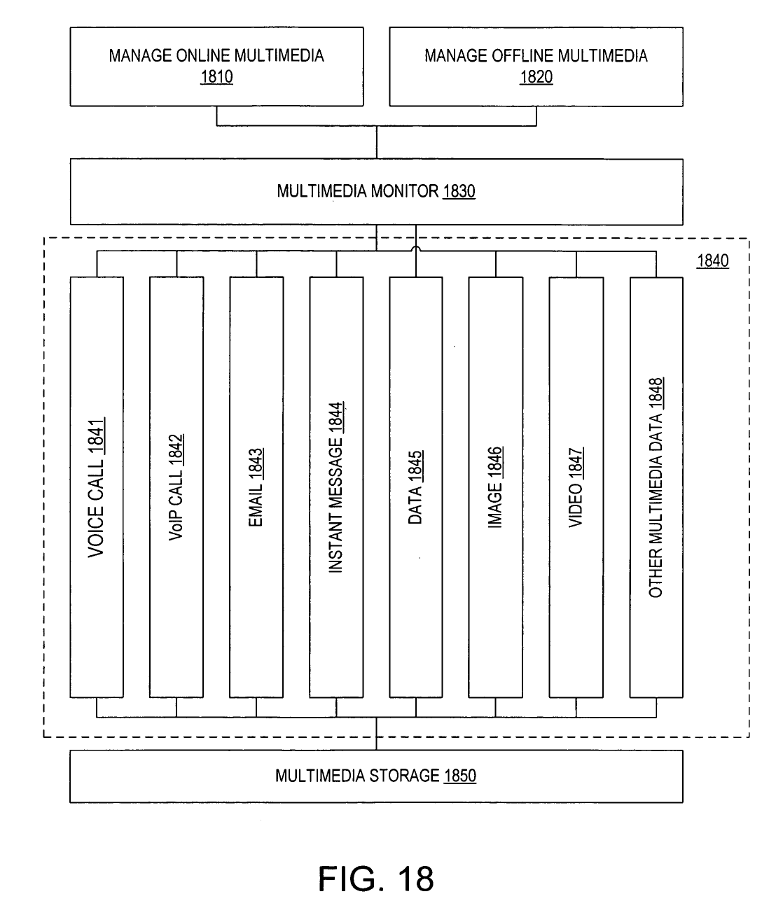

FIG. 18 is a schematic block diagram showing various functions of the communications controller 1250. A multimedia manager 1830 includes a section 1810 for managing online multimedia data, and a section 1820 for managing offline multimedia data. The multimedia data 1840 includes voice calls 1841, VolP calls 1842, email 1843, instant messages 1844, data 1845, images 1846, video 1847, and other multimedia types 1848. The multimedia data may be stored locally in the mobile personal device in multimedia storage 1850.

As described above, this system allows the mobile user to move between cells of a similar network, such as an 802.11 Wi-Fi network, or between dissimilar networks. In either case, the mobile personal device automatically switches between cells while maintaining the current status of the connection and the current data transaction, if one is in progress. For example, if the cell switch crosses from one network carrier to another, from an internal corporate Wi-Fi to a T-Mobile Wi-Fi, the mobile personal device notifies the user of the change, the impending charges, any potential security ramifications and other relevant communications related parameters. The user thus notified, has the option to accept the new connection or have the mobile personal device scan all alternative connections, including other similar networks as well as dissimilar networks. The user may select which of the available networks to activate.

Advantageously, the mobile personal device may be reconfigurable based on the user's identity. In an exemplary embodiment, not only is the device profile configured for the current user, but the applications and data are also configured so as to be specific for the current user. The SIM card, Biometrics identifier, or other acceptable personal identifier provides the ability to link and secure the data on the mass storage device to the identity of the current user. Through this capability, the current user may “take ownership” of the mobile personal device. If the mobile personal device is transferred from a prior user to the current user, the current user puts his SIM card or other personal identifier such as biometrics in place. The data belonging to the prior user is thereby made inaccessible to the current user. The data belonging to the prior user may be secured by, for example, encryption on the storage medium or deletion, wither with our without archiving to a remote server over a connected network. The current user's applications and data, or selected applications and data, are loaded onto the mass storage medium of the mobile personal device by download from, for example, a remote archival server, an application service provider (“ASP”), and so forth. The current user preferably is not permitted access to the prior user's data or applications.

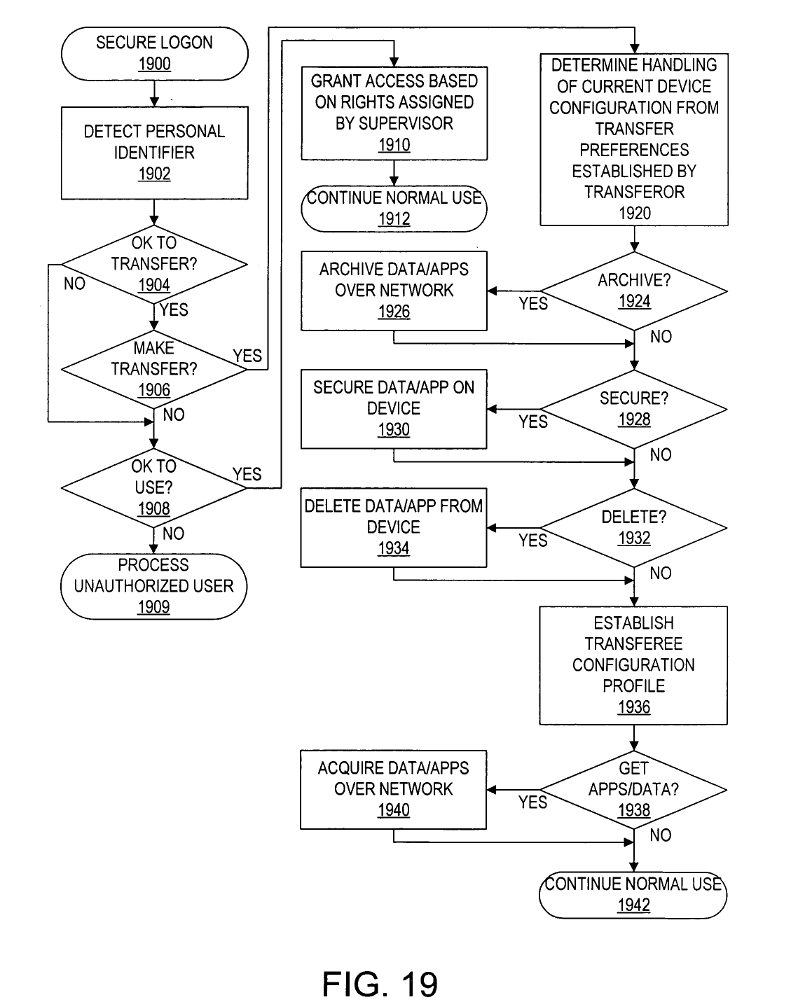

FIG. 19 is a flowchart of an illustrative secure logon process 1900 for reconfiguring a mobile personal device to a new user. The new user presents his personal identifier (block 1902). Based on previously established permissions, which may be established by the prior user with preferably supervisor access, by a supervisor other than the prior user such as an IS officer of an enterprise, a check is made to determine whether the new user is authorized to take ownership of the mobile personal device. If the new user is authorized to take ownership (block 1904—yes), the new user is asked whether he wishes to take ownership of the mobile personal device, as opposed to just using the device. If the new user wishes to take possession (block 1906—yes), the process continues with various operations to put into effect the change in ownership. However, if the new user does not wish to take ownership (block 1906—no), or if the new user is not authorized to take ownership (block 1904—no), a check is made to determine whether the new user is authorized to use the mobile personal device (block 1908). If the new user is authorized to use the mobile personal device (block 1908—yes), the new user is granted access based on rights assigned by the supervisor (block 1910) and may continue use (block 1912). If the new user is not authorized to use the mobile personal device (block 1908—no), the new user is considered to be an unauthorized user and appropriate action may be taken by the mobile personal device (block 1909).

If the new user wishes to take possession (block 1906—yes), a determination is made of how to handle the current device configuration based on transfer preferences established by the transferor or by the supervisor (block 1920). The transfer preferences specify how to handle applications and data on the mobile personal device. Sensitive data may be deleted (block 1932—yes and block 1934) or encrypted and maintained on the mass storage device of the mobile personal device (block 1928—yes and block 1930), and may in addition be archived remotely if desired (block 1924—yes and block 1926). Applications that would be unlicensed if used by the new user may be deleted or blocked (block 1932—yes and block 1934). Applications that are also licensed to the new owner and data that is not of a sensitive or personal nature or that is suitable for use by the new owner may be left on the mobile personal device for access by the new owner, if desired.

The transferee then establishes a configuration profile (block 1936). In this profile, the new owner specifies whether the mobile personal device should be configured with all of his applications and data, or only selected applications and data. Applications and data are then acquired over any suitable available network, from archival servers, ASPs, and so forth (block 1938—yes and block 1940). The new owner may then proceed with full use of the mobile personal device.

Advantageously, the transfer of the mobile personal device from one owner to the next is performed in a manner that is highly automated and nearly transparent to the old owner as well as the new owner. The capability of the mobile personal device to perform seamless network switching and maintain session persistence allows archival, encryption, and downloading operations to occur continuously from the time the transfer is made until the mobile personal device is completely reconfigured for the new owner, without need for any intervention by the new owner. While reconfiguration is taking place, the cellular functions and communications management functions of the mobile personal device may be activated and functioning. The mobile personal device may keep track of the status of uninstalled applications and data so that a communication requiring the availability of an uninstalled application or data may be appropriately handled, such as by storing the communication until the application or data is installed, by notifying the sender that the data cannot be received, or other manner of handling.

### COMMERCIAL MARKET EXAMPLES

Certain commercial (vertical) markets are now discussed as examples of markets in which mobile personal devices and their capabilities for seamless connections management and session and application persistence are ideally suited and create novel opportunities. These exemplary markets are medical, legal/government, manufacturing and retail/distribution, and financial. These industries have shown a strong interest in an integrated modular computing system such as that afforded by the mobile personal device.

### Example 1—Medical Market

Medical providers face stiff cost pressures. They are looking to technology for assistance in reducing costs while improving their service delivery. Physicians are looking for ways to better utilize their time. Physicians need a simple, lightweight device to access patient information, receive updates (such as a patient admittance information), and communicate with other physicians and lab staff.

Today, most hospitals and clinics deploy between 6 and 8 desktop systems per doctor on duty at any given time. A physician carrying his or her own mobile personal device would increase the physician's access to real-time information, reduce the number of systems required and lower their support costs.

### Example 2—Legal Market

The legal system faces challenges in handling high volumes of legal documents. Lawyers utilize computer technology to produce legal documents, yet still print these documents out hard copy for delivery to the courthouse. Electronic filing will soon become a reality in many states. Once courts have received documents in digital format they need a system effectively utilize them. Deploying current PCs would result in courts facing similar ratios of PCs to staff as is experienced in hospitals and clinics. A modular, wireless systems, such as the mobile personal device, capable of receiving automatic updates, would not only provide paralegals, lawyers and judges with cost effective devices to meet the demands placed on them.

### Example 3—Financial Market

Financial Institutions are looking for ways to reduce costs as they are forced to compete with increasingly automated customer service. This has forced some banks to close branches and reallocate their remaining tellers between multiple branches. This requirement is causing security and authentication problems. Security mandates require that the user (as well as the network connection) be authenticated and possibly encrypted. The use of the mobile personal device provides the necessary solution to address these challenges. This capability provides the necessary benchmark since strong security is a top requirement within our financial institutions.

### Example 4—Manufacturing and Retail

The mobile personal device provides manufacturing and retail/distribution users solutions for use on shop floors and throughout production facilities. Blueprints and component specifications may be immediately accessed through wireless connections as engineers encountered problems or issues. A user is able to review numerous articles regarding the improvement of a particular process while working within the middle of the process. Retail clerks may answer inventory related questions while talking with a customer on the shop floor, rather than retreating to a wired device and taking the risk that the customer wanders away. Real time information can be accessed by those who need it, when they need it, and, most importantly, where they need it while facilitating faster response times and greater customer service.

In addition to the corporate customer, the mobile personal device will also be popular in the consumer market.

Following is a summary of some of the various embodiments described herein.

1. A mobile personal computing and communications device comprising:

a microprocessor;

a screen coupled to the microprocessor;

a mass storage device coupled to the microprocessor;

a GSM wireless circuit coupled to the microprocessor, the GMS wireless circuit having a SIM card; and

a broadband wireless circuit coupled to the microprocessor;

wherein the SIM card is accessible to the microprocessor for authenticating user identity and for supporting secure network connections through the GSM wireless circuit and the broadband wireless circuit.

2. A method for reconfiguring a mobile personal computing and communications device from a prior user to a new user, comprising:

identifying the new user;

authenticating the new user to take ownership of the device;

disposing of data and applications of the prior user from the device; and

establishing data and applications for the new user on the device seamlessly across multiple networks with session persistence.

3. A method for securely managing communications across multiple networks, comprising:

requesting connection to a web site from a mobile personal device;

establishing a first secure connection between the mobile personal device and a connection manager;

maintaining the first secure connection seamlessly across multiple networks with session persistence;

establishing a second secure connection between the connection manager and the web site; and

managing the connection between the mobile personal device and the web site with the connection manager, through the first secure connection and the second secure connection.

4. A mobile personal computing and communications device comprising:

a main screen coupled to a microprocessor;

a mass storage device coupled to the microprocessor;

a cellular phone circuit coupled to the microprocessor; and

an auxiliary touch screen coupled to the cellular phone circuit for displaying phone-related information, and coupled to the microprocessor for controlling cursor movement on the main screen.

5. A method for managing communications with a mobile personal device, comprising:

establishing connection parameters for a plurality of connection types;

establishing weightings for the connection parameters;

detecting connections available to the mobile personal device;

evaluating the connection parameters for the detected connections; and

applying the weightings to the evaluated connection parameters to select one of the detected connections for the communications.

6. A method for selectively triggering processes and applications on a mobile personal device, comprising:

monitoring events accessible to the mobile personal device from local and remote processes and applications;

identifying triggers in the monitored events;

initiating autonomous execution of other processes and applications on the mobile personal device from the triggers; and

monitoring the initiated processes and applications.

7. A method for selectively triggering processes and applications on a mobile personal device, comprising:

initiating execution of processes and applications on the mobile personal device;

monitoring events accessible to the mobile personal device from the processes and applications executing on the mobile personal device and remote from the mobile personal device;

identifying triggers in the monitored events; and

updating at least some of the processes and applications executing on the mobile personal device from the triggers.

8. A modular computing environment comprising:

a self-powered mobile personal computing and communications device comprising:

a microprocessor capable of running standard business application software;

a screen coupled to the microprocessor;

a mass storage device coupled to the microprocessor;

a cellular phone circuit coupled to the microprocessor; and

an I/O circuit coupled to the microprocessor and the cell phone circuit; and

a self-powered mobile user interface device comprising:

a standard business size display screen;

a standard business size keyboard; and

an I/O circuit coupled to the display screen and to the keyboard;

the mobile personal computing and communications device being coupled to the mobile user interface device through the respective I/O circuits thereof.

9. A hand-held personal computer and communications device, comprising:

a processor unit containing a microprocessor;

a cellular communications unit;

a mass storage unit operatively coupled to the processor unit; and

a user interface to permit user interaction with the processor unit and the cellular communications unit;

wherein the processor unit, the cellular communications unit, the permanent data storage unit and the user interface are contained within a hand-held housing.

10. The device of paragraph 9, further comprising a connectivity interface unit to provide integrated multi-network communications capability.

11. The device of paragraph 9, wherein the user interface unit includes a one-touch speakerphone.

12. The device of paragraph 9, wherein the user interface unit includes an LCD display.

13. The device of paragraph 12, wherein the LCD display includes a touch screen.

14. The device of paragraph 9, further comprising a wireless interface for connecting to a wireless network.

15. The device of paragraph 9, further comprising an interface for coupling to a peripheral device.

16. The device of paragraph 15, wherein the peripheral device is a docking station.

17. The device of paragraph 16, further comprising the docking station.

18. The device of paragraph 15, wherein the interface is a universal electrical interface.

19. The device of paragraph 15, wherein the device is an external display.

20. The device of paragraph 15, wherein the device is an external keyboard.

21. The device of paragraph 9, wherein the mass storage unit has a capacity in excess of 2 Gbytes.

22. The device of paragraph 9, wherein the mass storage unit has a capacity in excess of 10 Gbytes.

23. The device of paragraph 9, wherein the microprocessor is capable of running standard business application software.

The description of the invention and its applications as set forth herein is illustrative and is not intended to limit the scope of the invention. Variations and modifications of the embodiments disclosed herein are possible, and practical alternatives to and equivalents of the various elements of the embodiments are known to those of ordinary skill in the art. These and other variations and modifications of the embodiments disclosed herein may be made without departing from the scope and spirit of the invention.

1. A modular computing environment comprising:
a self-powered mobile personal computing and communications device comprising:
a microprocessor capable of running standard business application software;
a mass storage device coupled to the microprocessor;
a GSM wireless cell phone circuit coupled to the microprocessor, the GMS wireless circuit having a SIM card that is accessible to the microprocessor for authenticating user identity and for supporting secure network connections through the GSM wireless circuit and the broadband wireless circuit;
a local area wireless networking circuit coupled to the microprocessor;
a personal area wireless networking circuit coupled to the microprocessor;
a wired connectivity port coupled to the microprocessor; and
a main screen coupled to a microprocessor; and
a self-powered mobile user interface device comprising:
a standard business size display screen;
a standard business size keyboard; and
an I/O circuit coupled to the display screen and to the keyboard;
the mobile personal computing and communications device being coupled to the mobile user interface device through at least one of the local area wireless networking circuit, the personal area wireless networking circuit, and the wired connectivity port.

2. A method for operating a mobile personal computing and communications device, comprising:
securely managing communications across multiple networks by:
requesting connection to a web site from the mobile personal device;
establishing a first secure connection between the mobile personal device and a connection manager;
maintaining the first secure connection seamlessly across multiple networks with session persistence;
establishing a second secure connection between the connection manager and the web site; and
managing the connection between the mobile personal device and the web site with the connection manager, through the first secure connection and the second secure connection;
reconfiguring the mobile personal computing and communications device from a prior user to a new user by:
identifying the new user;
authenticating the new user to take ownership of the device;
disposing of data and applications of the prior user from the device; and
establishing data and applications for the new user on the device seamlessly across multiple networks with session persistence;
managing communications by:
establishing connection parameters for a plurality of connection types;
establishing weightings for the connection parameters;
detecting connections available to the mobile personal device;
evaluating the connection parameters for the detected connections; and
applying the weightings to the evaluated connection parameters to select one of the detected connections for the communications; and
selectively triggering processes and applications on a mobile personal device by:
monitoring events accessible to the mobile personal device from local and remote processes and applications;
identifying triggers in the monitored events;
initiating autonomous execution of other processes and applications on the mobile personal device from the triggers; and
monitoring the initiated processes and applications.
